(19) United States
(12) Patent Application Publication
(10) Pub. No.: US 2024/0418551 A1
(43) Pub. Date: Dec. 19, 2024

(54) MONITORING APPARATUS AND METHOD FOR MONITORING OPERATION OF FLUID DISPENSING SYSTEM

(71) Applicant: Scarab Solutions Ltd, Southhampton (GB)

(72) Inventors: Lisbet RIIS, Southhampton (GB); Mikkel GRUM, Southhampton (GB)

(73) Assignee: Scarab Solutions Ltd, Southhampton, HA (GB)

(21) Appl. No.: 18/720,829

(22) PCT Filed: Dec. 19, 2022
(86) PCT No.: PCT/IB2022/062469

§ 371 Date: Jun. 17, 2024

(30) Foreign Application Priority Data
Dec. 22, 2021 (GB) 2118750.5

(51) Int. Cl. G01F 1/684; B05B 12/00; G01F 15/063; G01F 15/14; G01F 15/18; G01K 13/02

(52) U.S. Cl. CPC G01F 1/684; B05B 12/008; G01F 15/063; G01F 15/14; G01F 15/185; G01K 13/026

(57) ABSTRACT

A monitoring apparatus that monitors an operation of a fluid dispensing system. The fluid dispensing system includes at least one storage unit, a dispensing arrangement, and a pumping arrangement for providing a flow of the fluid from to the dispensing arrangement. The monitoring apparatus includes a sensing arrangement that is connected to the fluid dispensing system, wherein the sensing arrangement measures operational performance of the flow of the fluid dispensed through the dispensing arrangement and a server arrangement communicably coupled to the sensing arrangement via a data communication network. The server arrangement acquires the operational performance of the flow of the fluid dispensed, generates an actionable information for adjusting optimal dispensing of the fluid and provides the actionable information to a user device to report an operational status of the fluid dispensing system.

### TECHNICAL FIELD

The present disclosure relates generally to systems and methods for monitoring operations; more specifically, the present disclosure relates to monitoring apparatuses and methods for monitoring operation of mobile liquid dispensing systems, for example mobile liquid dispensing systems that are personnel-carried.

### BACKGROUND

The world population is estimated to reach 9.7 billion by 2050, necessitating dramatic increases in food production and agricultural productivity. Crop losses caused by pests and diseases are major barriers to increasing agricultural production. Pesticides and biopesticides control solutions are an important component of a comprehensive strategy to increase crop yield by preventing pre/postharvest loss to pests and diseases. However, many misuses and poor pesticide practices are carried out by farmers including under/overdosage, wrong targeting, poor coverage, and lack of knowledge/education.

Poor pesticide coverage is one of the causes of pesticide resistance in crop production, leaving some of the pests or disease populations only partly controlled due to insufficient coverage. All of this comes at a high cost and frustrates both farmers and pesticide manufacturers.

Environmentally friendly and less toxic compounds, such as natural compounds of microbial/botanical solutions, also referred to as biopesticides, rarely provide quick knockout control or a systemic mode of action, but rely on contact, and hence, good coverage is key, and for these, it is even more critical to be able to control and assure a correct distribution of the compound throughout the field or greenhouse.

Throughout the world, and especially in the tropics, pesticides and biopesticides are often applied manually, employing backpack sprayers or handheld long-hose sprayers connected to a central tank. Despite the relatively high level of control on flower farms where the crop is grown in carefully managed greenhouses, a major and persistent complaint from farm managers is their lack of means to control their spray operators.

A major issue with deploying backpack sprayers and long-hose systems is the lack of uniformity and often carelessness in spraying techniques. If sprayers walk too fast, pesticide coverage is inadequate for effective pest and disease control; if sprayers walk too slowly, pesticides will be used up before the entire crop area is covered. Managers of plantations and open-field crops have even less control of this process.

Hence, there remains a need for improved application of pesticides and biopesticides to enhance pest and disease control. It is an object of the invention to address at least one of the above problems, or another problem associated with the prior art.

### SUMMARY

The present disclosure seeks to provide an improved monitoring apparatus that monitors an operation of a fluid dispensing system, for example a liquid dispensing system, a gas dispensing system, a foam dispensing system. The present disclosure also seeks to provide a method for monitoring operation of a fluid dispensing system, for example a liquid dispensing system, a gas dispensing system, a foam dispensing system. The present disclosure seeks to provide a solution to an existing problem of uncoordinated and suboptimal operation of the fluid dispensing owing to manual dependency when implementing the spraying. An aim of the present disclosure is to provide a solution that overcomes at least partially the problems encountered in prior art, and provides a monitoring apparatus that assists operation of fluid dispensing, thereby substantially decreasing dependency on human knowledge for such operation of the fluid dispensing system.

A first aspect of the invention provides a monitoring apparatus that, when in operation, monitors an operation of a fluid dispensing system, wherein the fluid dispensing system comprises at least one storage unit that stores a fluid, a dispensing arrangement, and a pumping arrangement that provides a flow of the fluid from the at least one storage unit to the dispensing arrangement;

wherein the monitoring apparatus comprises:
a sensing arrangement that, when in operation, is connected to the fluid dispensing system, wherein the sensing arrangement measures operational performance of the flow of the fluid dispensed through the dispensing arrangement; and
a server arrangement that is communicably coupled to the sensing arrangement via a data communication network, wherein the server arrangement:
   acquires the operational performance of the flow of the fluid dispensed and generates an actionable information for adjusting optimal dispensing of the fluid; and
   provides the actionable information to a user device to report an operational status of the fluid dispensing system.

A second aspect of the invention provides a method for monitoring operation of a fluid dispensing system, the fluid dispensing system comprising at least one storage unit for storing a fluid, a dispensing arrangement, and a pumping arrangement for providing a flow of the fluid from the at least one storage unit to the dispensing arrangement; wherein the method is implemented using a monitoring apparatus comprising a sensing arrangement connectable to the fluid dispensing system and a server arrangement communicably coupled to the sensing arrangement via a data communication network;

wherein the method comprises:
measuring, using the sensing arrangement, operational performance of the flow of the fluid dispensed through the dispensing arrangement;
acquiring, by the server arrangement, the operational performance of the flow of the fluid dispensed;
generating, using the server arrangement, an actionable information for adjusting optimal dispensing of the fluid; and
providing the actionable information to a user device to report an operational status of the fluid dispensing system.

It will be appreciated that, in the aspects above, liquids are usually dispensed, although other types of fluids are optionally dispensed as an alternative.

Embodiments of the present disclosure substantially eliminate or at least partially address the aforementioned problems in the prior art, and enables methodical and efficient operation of fluid dispensing system thereby optimizing a process relating to application of fluid from the fluid dispensing system.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

Embodiments of the present disclosure will now be described, by way of example only, with reference to the following diagrams wherein:

FIG. 1 is a schematic illustration of a monitoring apparatus that monitors an operation of a fluid dispensing system, for example a liquid dispensing system, in accordance with an embodiment of the present disclosure;

FIG. 2 is a schematic illustration of a sensing arrangement, in accordance with an embodiment of the present disclosure;

FIG. 3 is a schematic illustration of a dispensing arrangement, in accordance with an embodiment of the present disclosure;

FIG. 4 is a schematic illustration of a network environment where the monitoring apparatus is implemented, in accordance with an embodiment of the present disclosure;

FIG. 5 is a schematic illustration of a flow chart depicting steps of a method for monitoring operation of a fluid dispensing system, for example a liquid dispensing system, in accordance with an embodiment of the present disclosure;

FIG. 6 is a perspective view of a tube for a sensing arrangement having raised O-ring portions;

FIG. 7 is a perspective view of the tube of FIG. 6 fitted with rubber O-rings;

FIG. 8 is a perspective view of the tube of FIG. 7 engaged with support portions;

FIG. 9 is a perspective view of the tube of FIG. 8 fitted with a first cover portion;

FIG. 10 is an exploded view of the tube of FIG. 9 and a PCB assembly;

FIG. 11 is a perspective view of a PCB assembly mounted within the tube of FIG. 9;

FIG. 12 is a perspective view of a fully assembled sensor arrangement;

FIG. 13 is an exploded view of a of a tube for a sensing arrangement and first and second support portions in accordance with an alternative embodiment of the invention;

FIG. 14A is a perspective view of the tube of FIG. 13 arranged within the first and second support portions;

FIG. 14B is a cross-sectional view of the tube of FIG. 13 arranged within the first and second support portions;

FIG. 15 is an exploded view of a PCB assembly and first cover portion of a sensing arrangement in accordance with a further embodiment of the invention;

FIG. 16 is a view of the PCB assembly and first cover portion of FIG. 15 showing the PCB assembly inserted into the first cover portion;

FIG. 17 is view of the PCB assembly and first cover portion of FIG. 16 with a tube also inserted into the first cover portion;

FIG. 18 is view of the PCB assembly and first cover half of FIG. 17 being connected to a second cover portion;

FIG. 19 is a view of the connected first and second cover portions of FIG. 18 being connected to an outer cover portion;

FIG. 20 is a view of a fully assembled sensing arrangement of the embodiment of FIGS. 15 to 19 with a removable bespoke clip and a strap, and a USB charging pad;

FIG. 21A is a schematic illustration of an image of a GNSS track of crop spraying prior to being aligned with an underlying satellite image of a sprayed field; and

FIG. 21B is a schematic illustration of the image of a GNSS track of spraying of FIG. 21A after having been aligned with the underlying satellite image of the sprayed field.

### DETAILED DESCRIPTION OF EMBODIMENTS

A first aspect of the invention provides a monitoring apparatus that, when in operation, monitors an operation of a fluid dispensing system, for example a liquid dispensing system, wherein the fluid dispensing system comprises at least one storage unit that stores a fluid, a dispensing arrangement, and a pumping arrangement that provides a flow of the fluid from the at least one storage unit to the dispensing arrangement;

wherein the monitoring apparatus comprises:
a sensing arrangement that, when in operation, is connected to the fluid dispensing system, wherein the sensing arrangement measures operational performance of the flow of the fluid dispensed through the dispensing arrangement; and
a server arrangement that is communicably coupled to the sensing arrangement via a data communication network, wherein the server arrangement:
   acquires the operational performance of the flow of the fluid dispensed and generates an actionable information for adjusting optimal dispensing of the fluid; and
   provides the actionable information to a user device to report an operational status of the fluid dispensing system.

A second aspect of the invention provides a method for monitoring the operation of a fluid dispensing system, for example a liquid dispensing system, the fluid dispensing system comprising at least one storage unit for storing a fluid, a dispensing arrangement, and a pumping arrangement for providing a flow of the fluid from the at least one storage unit to the dispensing arrangement;

wherein the method is implemented using a monitoring apparatus comprising a sensing arrangement connectable to the fluid dispensing system and a server arrangement communicably coupled to the sensing arrangement via a data communication network;
wherein the method comprises:
measuring, using the sensing arrangement, operational performance of the flow of the fluid dispensed through the dispensing arrangement;
acquiring, by the server arrangement, the operational performance of the flow of the fluid dispensed;
generating, using the server arrangement, an actionable information for adjusting optimal dispensing of the fluid; and
providing the actionable information to a user device to report an operational status of the fluid dispensing system.

The monitoring apparatus described herein overcomes drawbacks associated with presently utilized fluid dispensing systems, for example liquid dispensing systems, such as manual sprayers and semi-automated sprayers. Moreover, the monitoring apparatus overcomes limitations associated with conventional fluid dispensing systems deployed for, for example, pest control. Specifically, the monitoring apparatus may enable optimal operation of the conventional fluid dispensing systems thereby preventing problems associated with incoherent operation of the fluid dispensing systems owing to multiple users, inadequate application of the fluid from the fluid dispensing system. Optimal operation of the fluid dispensing system may further prevent problems such as, for example, crop losses in agricultural fields, health risks owing to contamination of food and/or water, damage of clothing, damage of buildings, damage of storage units, and the like.

The monitoring apparatus as described in the present disclosure may help to target interventions (for example, pest controls) and to keep a track of the operations of the fluid dispensing system. Beneficially, monitoring the operations of the fluid dispensing system may enable the identification of operational performance associated therewith (for example, specific sections where the fluid dispensing system has been operated). Notably, the server arrangement may analyse the operational performance acquired by the sensing arrangement to identify a state of operation of the fluid dispensing system, such as, flow of the fluid, pressure of the fluid, temperature of the fluid, and so forth; as aforementioned, it will be appreciated that the fluid is usually a liquid, although foams or gases are optionally alternatively dispensed. Such a state of operation of the fluid dispensing system may enable identification of faults therein. Therefore, the monitoring apparatus may ensure efficient and effective operation of the fluid dispensing system. Moreover, the monitoring apparatus may enable optimal usage of the fluid through the fluid dispensing system thereby allowing significant savings in an amount of the fluid used. Additionally, the monitoring apparatus may increase a precision of application of the fluid in a given area thereby making operation of the fluid dispensing system more time-efficient.

In an example, the monitoring apparatus closely monitors the operations of the fluid dispensing system in an agricultural field. The fluid may, for example, comprise a pesticide, herbicide, insecticide, fungicide, biopesticide, miticide, fungicide, bactericide, nematicide, molluscicide, piscicide, avicide, rodenticide, insect repellent, animal repellent, antimicrobial, lampricide, fertiliser, hormone agent, and/or sterilising agent. The fluid may also comprise an additive such as a surfactant, foaming agent and/or adhesive. The monitoring apparatus may advantageously enable the quick, economical and effective eradication of pests, diseases and weeds from crops in agricultural fields, thereby reducing agricultural losses. Additionally, enabling the optimal usage of the fluid in agricultural fields may further prevent health risks to consumers as well as farmers, owing to contact with pests and/or injudicious amounts of any toxic chemicals in the fluid. Moreover, the optimal usage of the fluid in agricultural fields may prevent environmental damage owing to contamination of water and/or soil due to injudicious amounts of the fluid and health risks associated with consumption of the fluid by animals such as bees, and so forth.

It will be appreciated that when a plurality of fluid dispensing systems are deployed in a given area, the monitoring apparatus may monitor the operation of each of the plurality of fluid dispensing systems. Subsequently, the monitoring apparatus may enable identification of, for example, faults, sections where application of the fluid is ineffective, and sections where the application of fluid was not performed. Moreover, the monitoring apparatus may allow synchronized and coherent operation of the plurality of fluid dispensing systems in the given area, thereby optimizing output from operation of the plurality of fluid dispensing systems.

The monitoring apparatus may monitor the operations of the fluid dispensing system. Optionally, the fluid may comprise a pesticide or biopesticide and the fluid dispensing system may be employed for pesticide or biopesticide application to control pests and diseases on crops and in stores, houses, kitchens, wardrobes, poultry farms, barns, and so forth. Optionally, the fluid may comprise a pesticide or biopesticide and the fluid dispensing system may be employed for pesticide application to control insects and/or phytophagous mites, and/or for fungicide and/or bactericide application to control plant diseases. Optionally, the fluid may comprise a herbicide and the fluid dispensing system may be employed for herbicide application to kill weeds. Optionally, the fluid may comprise a hormone agent and the fluid dispensing system may be employed for hormone agent application to increase output from crops. Optionally, the fluid may comprise a fertiliser and the fluid dispensing system may be employed for foliar feeding to provide nutrients to plants. In some embodiments, the fluid dispensing system may be employed for applying powdery formulations of chemicals, for example aqueous suspensions of solids.

Throughout the present disclosure, the term “fluid dispensing system” refers to an apparatus that holds a fluid therein. Moreover, the fluid dispensing system may release the fluid for application thereof. In some embodiments, the fluid dispensing system may atomise the fluid into small droplets (namely, mist) and, optionally, release it with little force for proper distribution. Optionally, the fluid dispensing system may regulate an amount of fluid released therefrom to avoid excessive release or dearth release of the fluid. Moreover, optionally, an energy employed for atomising the fluid for release thereof may be at least one of: hydraulic energy, kinetic energy, gaseous energy, centrifugal energy, human manual effort. Suitably, a motorised pump may be employed for atomising the fluid.

In some embodiments, the fluid dispensing system may be operated manually using plunger, bellow or a rotary means, or power operated for performing operation of dispensing the fluid. Examples of the fluid dispensing systems include, but are not limited to, hand sprayer, compression sprayer, stirrup pump, knapsack sprayer, backpack sprayer, rocker sprayer, bucket sprayer, foot sprayer, power sprayer, and long hose sprayer.

Optionally, the fluid in the fluid dispensing system may comprise an emulsion, a solution, and/or a suspension. Optionally, the emulsion, the solution and/or the suspension may be aqueous in nature. More optionally, the fluid in the fluid dispensing system may comprise a pesticide, herbicide, insecticide, fungicide, pesticide, biopesticide, miticide, fungicide, bactericide, nematicide, molluscicide, piscicide, avicide, rodenticide, insect repellent, animal repellent, antimicrobial, lampricide, fertiliser, hormone agent, and/or sterilising agent. The fluid in the fluid dispensing system may also comprise an additive such as a surfactant, foaming agent and/or adhesive.

The fluid dispensing system may comprise at least one storage unit that stores the fluid, a dispensing arrangement, and a pumping unit that provides the flow of the fluid from the at least one storage unit to the dispensing arrangement. Specifically, the at least one storage unit may store the fluid therein. Optionally, the at least one storage unit may store the fluid under pressure. It will be appreciated that the at least one storage unit may have at least one opening for filling the fluid. Optionally, the at least one storage unit may be cylindrical in shape. Moreover, optionally, the at least one storage unit may further comprise openings for attaching an air pump to pump air in the at least one storage unit, attaching the dispensing arrangement and/or attaching a pressure gauge that measures the pressure of the at least one storage unit. In an example, the at least one storage unit may be fabricated from stainless steel.

Moreover, the dispensing arrangement may deliver a precise amount of the fluid at a certain given pressure and, optionally, at a certain given flow rate (per unit time). Moreover, beneficially, the dispensing arrangement may maintain a uniform pattern and swath width for delivering the fluid. Optionally, the dispensing arrangement may comprise at least one of: a dip-tube, a hose, a filter, a cut-off valve, a handle, a lance, a nozzle. Moreover, optionally, examples of a type of the nozzle in the dispensing arrangement include, a jet-stream nozzle, a flat-spray nozzle, a hollow-cone nozzle, and a solid-cone nozzle.

Furthermore, the fluid dispensing system may comprise a pumping unit for providing a flow of the fluid from the at least one storage unit to the dispensing arrangement. Specifically, the pumping unit may be operated to allow a precise mechanical flow of the fluid from the at least one storage unit to the dispensing arrangement. Optionally, the pumping unit may comprise a valve assembly that enables a pressurized flow of the fluid from the at least one storage unit to the dispensing arrangement. More optionally, the pumping unit may be implemented using a motoring device.

Optionally, the fluid dispensing system may comprise an agitator to agitate the fluid. More optionally, the fluid dispensing system may comprise handling straps for enabling carrying of the fluid dispensing system. This may enhance mobility of the fluid dispensing system.

The monitoring apparatus may comprise the sensing arrangement. Notably, the sensing arrangement may detect events or changes in an environment where the fluid dispensing system is operated. Typically, the sensing arrangement may comprise at least one sensor for sensing the operational performance associated with the fluid dispensing system.

Optionally, the sensing arrangement may comprise at least one sensor selected from: a flow sensor to measure the flow of the fluid dispensed, a pressure sensor, a location tracker to measure a spatial position of the fluid dispensing system, an accelerometer, a constant temperature anemometry flow sensor (i.e. calorimetric flow sensor) and/or a thermometer. It will be appreciated that the constant temperature anemometry flow sensor may be sufficient for measuring fluid flow and thus may advantageously represent a simple and robust solution. Typically, the flow sensor measures a rate of the flow of the fluid dispensed by quantifying the flow (namely, a movement) of the fluid when delivering the fluid from the fluid dispensing system. The flow sensor may, for example, be an obstruction type sensor, an inferential type sensor, an electromagnetic sensor, a positive-displacement flow meter, a fluid dynamic-based sensor, an anemometer sensor, an ultrasonic sensor, and a mass flowmeter sensor. Additionally, the pressure sensor may determine a pressure of at least one of: the fluid stored in the at least one storage unit, the fluid dispensed (namely, delivered) from the fluid dispensing system.

Beneficially, using a non-obstructive flow sensor, i.e. a sensor which does not obstruct the flow of fluid through the device, such as a calorimetric sensor, as opposed to an obstructive sensor, such as a vane wheel sensor, may enable the sensing arrangement to endure high-pressure flow rates, for example, of 40 bar or more. Moreover, obstructive sensors are prone to blockages if the fluid contains solid particles, and so the use of a non-obstructive flow sensor may advantageously mitigate this problem. Moreover, the location tracker may use satellites to determine autonomous geo-spatial positioning of the fluid dispensing system. The location tracker may be implemented using a Global Navigation Satellite System (GNSS), for example such as Global Positioning System (GPS), Global Navigation Satellite System (GLONASS), BeiDou Navigation Satellite System (BDS) and/or Galileo satellite navigation (GALILEO). For example, the location tracker may comprise a chip that employs a Global Navigation Satellite System (GNSS), for example such as Global Positioning System (GPS), Global Navigation Satellite System (GLONASS), BeiDou Navigation Satellite System (BDS) and/or Galileo satellite navigation (GALILEO). Suitably, the location tracker may comprise a receiver. Additionally, the location tracker may comprise an antenna connected to the receiver.

Additionally, an accelerometer may be used to measure an acceleration of the fluid dispensing system. Furthermore, a constant temperature anemometry flow sensor may heat the fluid slightly and further maintain a constant temperature to enable the flow sensor to measure the flow of the fluid dispensed. The flow sensor may therefore beneficially maintain a constant increase in temperature (relative to a temperature of the fluid measured before operation of a heating element) and further use a voltage excitation technique to operate the heating element that is necessary to maintain this constant increase in temperature as a measure of the flow of the fluid.

It will be appreciated that the constant temperature anemometry flow sensor may beneficially not comprise any moving part, thereby reducing the risk of clogging of parts therein, when the flow of the fluid is dispensed from the fluid dispensing system. Moreover, an inner surface of the constant temperature anemometry flow sensor may be fabricated from stainless steel. This may provide a constant temperature anemometry flow sensor that is economical to manufacture, easy to deploy, non-reactive (namely, inert) to chemicals in the fluid, capable of tolerating high pressure, and easy to clean.

In some embodiments, the sensing arrangement may comprise a location tracker to measure a spatial position of the fluid dispensing system. The location tracker may suitably be mounted on or in the sensing arrangement. Mounting the location tracker on or in the sensing arrangement may advantageously avoid the need for the monitoring apparatus to require an additional third-party device, such as a mobile phone or GNSS tracker, to measure a spatial position of the fluid dispensing system. Such a third-party system might otherwise have to be provided at the expense of the user, and could potentially be damaged or stolen. Further, mounting the location tracker on or in the sensing arrangement may also have the advantage that the location tracker cannot be easily separated from the sensing arrangement, which can help to reduce any potential tracking errors that could otherwise result from the sensing arrangement and the location tracker becoming separated. In some embodiments, the location tracker may comprise an integrated circuit (IC) or integrated chip.

In some embodiments, the sensing arrangement may be generally wedge shaped. For example, the sensing arrangement may have a wide side and a narrow side opposite the wide side. Suitably, the sensing arrangement may be generally trapezoidal prism (i.e. 3D trapezoidal) in shape. This may encourage the user of the sensing arrangement to attach or hold the sensing arrangement to their body or to the fluid dispensing system such that the wide side lies flat against their body or the fluid dispensing system, as such an arrangement may be more stable. Thus, the narrow side may be located the furthest distance away from the user's body or the fluid dispensing system. Suitably, the location tracker may be mounted on or in the sensing arrangement at or towards the narrow side.

In this way, if the user of the sensing arrangement attaches or holds the sensing arrangement to their body or to the fluid dispensing system such that the wide side (i.e. having the largest surface area) lies flat against their body or the fluid dispensing system, the location tracker may kept away from the user's body or the fluid dispensing system. This may advantageously reduce interference of the human body with the location tracker and therefore improve the ability of the location tracker to receive GNSS signals.

In some embodiments, the sensing arrangement may be generally trapezoidal prism (i.e. 3D trapezoidal) in shape, having two trapezoidal shaped bases (i.e. ends) and four (i.e. first, second, third and fourth) rectangular faces each defining a length and width. The lengths of all four rectangular faces may suitably be equal. The second and third rectangular faces may be of equal width, said width being greater than the width of the first rectangular face (i.e. the narrow side). The fourth rectangular face (i.e. the wide side) may have a width greater than the widths of each of the second and third rectangular faces. The first and fourth rectangular faces may suitably be opposite one another (i.e. opposed).

In some embodiments, one or more of the first, second, third and fourth rectangular faces may be curved. For example, one or more of the first, second, third and fourth rectangular faces may be convexly curved, i.e curving outwardly from the sensing arrangement. Suitably, the second and third rectangular faces may be curved.

In some embodiments, the sensing arrangement may be generally semi-cylindrical in shape. For example, each of the first, second and third may be curved in such a way that they form a single continuous curve.

In this way, the first rectangular face may have the smallest surface area of the four rectangular faces and the fourth rectangular face may have the largest surface area of the four rectangular faces. This may encourage the user of the sensing arrangement to attach or hold the sensing arrangement to their body or to the fluid dispensing system such that the fourth rectangular face (i.e. having the largest surface area) lies flat against their body or the fluid dispensing system, as such an arrangement may be more stable. Thus, the first rectangular face opposite to the fourth rectangular face may located the furthest distance away from the user's body or the fluid dispensing system.

The location tracker may suitably be mounted on or in the sensing arrangement at or towards the narrow side of the sensing arrangement, for example, at or towards the first rectangular face. In this way, if the user of the sensing arrangement attaches or holds the sensing arrangement to their body or to the fluid dispensing system such that wide side, for example, the fourth rectangular face (i.e. having the largest surface area) lies flat against their body or the fluid dispensing system, the location tracker may kept away from the user's body or the fluid dispensing system. This may advantageously reduce interference of the human body or dispensing system with the location tracker and therefore improve the ability of the location tracker to receive GNSS signals. In some embodiments, the location may comprise a receiver and/or antenna. Thus, the receiver and/or antenna may suitably be mounted on or in the sensing arrangement at or towards the narrow side of the sensing arrangement, for example, at or towards the first rectangular face. In this way, if the user of the sensing arrangement attaches or holds the sensing arrangement to their body or to the fluid dispensing system such that the wide side, for example, the fourth rectangular face (i.e. having the largest surface area) lies flat against their body or the fluid dispensing system, the receiver and/or antenna may kept away from the user's body or the fluid dispensing system. This may advantageously reduce interference of the human body or dispensing system with the receiver and/or antenna and therefore improve the ability of the receiver and/or antenna to receive GNSS signals.

In some embodiments, the sensing arrangement may comprise one or more indicator lights. The one or more indicator lights may suitably provide an indication of, for example, power on/off, remaining battery power, Bluetooth availability/connection and/or GNSS signal search/acquisition. One or more of the indicator lights may suitably comprise a light emitting diode (LED).

The one or more indicator lights may suitably be mounted in the narrow side of the sensing arrangement, for example in the first rectangular face. Beneficially, this may help encourage a user of the sensing arrangement to arrange the narrow side, for example, the first rectangular face, away from their body such that view of the light source is not hindered.

Thus, in embodiments wherein the location tracker, or receiver and/or antenna, are mounted at or towards the narrow side, for example, at or towards the first rectangular face, this may help to encourage the user to attach or hold the sensing arrangement to their body or to the fluid dispensing system such that the wide side, for example, the fourth rectangular face (i.e. having the largest surface area) lies flat against their body or the fluid dispensing system, such that the location tracker, or receiver and/or antenna, are kept away from the user's body or the fluid dispensing system. As mentioned above, this may advantageously reduce interference of the human body or dispensing system with the location tracker or receiver and/or antenna and therefore improve the ability to receive GNSS signals.

In some embodiments, the wide side, for example, the fourth rectangular face may comprise an attachment point for a removable clip (e.g. bespoke clip), strap, or belt, to enable the sensing arrangement to be more easily carried around. Moreover, the presence of an attachment point for a removable clip (e.g. bespoke clip), strap, or belt in or on the wide side may advantageously encourage a user to attach the sensing arrangement to their body or to the fluid dispensing system such that wide side, for example, the fourth rectangular face (i.e. having the largest surface area) lies flat against their body or the fluid dispensing system.

Thus, in embodiments wherein the location tracker, or receiver and/or antenna, are mounted at or towards the narrow side, for example, at or towards the first rectangular face, this may help to encourage the user to attach the sensing arrangement to their body or to the fluid dispensing system such that the wide side, for example, the fourth rectangular face (i.e. having the largest surface area) lies flat against their body or the fluid dispensing system, such that the location tracker, or receiver and/or antenna, are kept away from the user's body or the fluid dispensing system. As mentioned above, this may advantageously reduce interference of the human body or dispensing system with the location tracker or receiver and/or antenna and therefore improve the ability to receive GNSS signals.

In various embodiments of the invention, the sensing arrangement may comprise a tube in fluid connection with the fluid dispensing system. The tube may have first and second ends. The tube may comprise at least one sensor located within the tube. The tube may comprise a metal, for example, such as steel. In some embodiments, the tube may be 10 mm or more in length, or 20 mm or more in length, or 30 mm or more in length, or 40 mm or more in length, or 50 mm or more in length. In an embodiment the tube may have a length in the range of from 50 mm to 60 mm. Suitably, the diameter of the tube may be 2 mm or more, or 3 mm or more, or 4 mm or more, or 5 mm or more, such as 6 mm or more. In an embodiment, the diameter of the tube may be in the range of from 5 mm to 7 mm.

The sensor may comprise a thermometer. In some embodiments, the tube may optionally comprise a heating device located within the tube. In an embodiment, the tube may comprise first and second thermometers and a heating device. The first and second thermometers may be separated from each other by a distance (d) along the length of the tube. The heating device may be positioned adjacent to the first thermometer. The second thermometer may suitably be arranged downstream from the first thermometer. In this way, the difference in the temperatures recorded by the first and second thermometers when heat is applied to a fluid passing through the tube by the heating device can be used to determine the flow rate of the fluid.

The sensing arrangement may comprise first and second housing portions arranged to connect to one another to form a compartment for accommodating at least a portion the tube. Each of the first and second housing portions may comprise a locating portion for receiving the first and second ends of the tube respectively. The locating portion may suitably comprise a sleeve. The first and/or second housing portion may suitably comprise a plastic material. The first and/or second housing portion may, for example, be injection moulded.

The sensing arrangement may comprise a printed circuit board (PCB). The PCB may suitably be connected to a sensor and/or a heating device located within the tube, for example, by one or more wires. The one or more wires may pass through a wall of the tube from the outside to the inside of the tube through one or more inlets arranged in the wall of the tube. Suitably, the one or more inlets may be of generally the same diameter as the one or more wires. The PCB may suitably be accommodated in the compartment formed by the first and second housing portions connecting to one another.

In some embodiments, the tube may comprise a first raised portion (i.e. a first swage) projecting from the outside of the tube and being located at or towards the first end. Additionally, or alternatively, the tube may comprise a second raised portion (i.e. a second swage) projecting from the outside of the tube and being located at or towards the second end.

Suitably, the first and second raised portions may be arranged to engage and/or abut the first and second housing portions respectively, thereby locating the first and second housing portions with respect to the tube. For example, the first and/or second raised portion may be arranged to engage and/or abut a locating portion of the first and/or second housing portion. Suitably, the first and/or second raised portion may be arranged to engage and/or abut the inside of a sleeve of the first and/or second housing portion. The presence of first and/or second raised portions may advantageously allow the housing to be secured to the tube without the need for adhesives.

Suitably, the first and/or second raised portion may extend at least a portion the circumference of the tube. For example, the first and/or second raised portion may define a raised O-ring. This may advantageously allow the first and/or second raised portion to form a leak-proof seal with the first and/or second housing portions.

Suitably, a first and/or second washer may be provided between the first and/or second raised portions and the first and/or second housing portions. The first and/or second washer may suitably be O-shaped. The first and/or second washer may optionally comprise rubber, silicone, or any other suitable elastomeric material. In some embodiments, the first and/or second washer may be a rubber O-ring. The presence of a washer between the first and/or second raised portions and the first and/or second housing portions respectively may advantageously allow the sensing arrangement to tolerate pressures of 40 bar or more without leaking.

In some embodiments the first housing portion may comprise a first support portion and a first cover portion. The first support portion may have a cylindrical central portion having first and second ends. The central portion may have a conduit that passes through the central portion from the first end to the second end. In such embodiments, the locating portion may be arranged in the first cover portion. The locating portion may suitably be configured to receive the first support portion.

A first sleeve portion may project outwardly from the first end of the central portion and be arranged to receive an end of the tube. The internal diameter of the first sleeve portion may step down from a first wider diameter to a second narrower diameter in a direction towards the central portion thereby forming a shelf inside the first sleeve portion. A second sleeve portion may project outwardly from the second end of the central portion. A screw thread may be disposed on the inside wall of the second sleeve portion.

The first end of the tube may be inserted into the first sleeve portion until the first raised portion abuts the shelf inside the first sleeve portion and, optionally, the first end of the tube abuts the first end of the central portion thereby bringing the first end of tube into fluid connection with the conduit passing through the central portion of the first support portion.

In some embodiments, prior to inserting the first end of the tube into the first sleeve portion, a first washer may be passed over the end of the first tube until it abuts the first raised portion. In this way, when the first end of the tube is inserted into the first sleeve portion, the first washer may become sandwiched between the first raised portion of the tube and the shelf inside the first sleeve portion to form a seal. Such an arrangement may advantageously allow the sensing arrangement to tolerate pressures of 40 bar or more without leaking.

The first cover portion may be generally cup shaped, having four walls and a base defining an internal space. A tube portion in fluid connection with an aperture in the base of the first cover portion may project upwardly into the internal space to define the locating portion. A screw thread disposed on the outside of the tube portion may allow the first cover portion to engage with the screw thread disposed on the inside wall of the second sleeve portion of the first support portion, thereby providing for attachment of the first cover portion to the first support portion. The first support portion and/or the first cover portion may suitably comprise a plastic material. The first support portion and/or the first cover portion may, for example, be injection moulded.

In some embodiments the second housing portion may comprise a second support portion and a second cover portion. The second support portion may have a cylindrical central portion having first and second ends. The central portion may have a conduit that passes through the central portion from the first end to the second end.

A first sleeve portion may project outwardly from the first end of the central portion and be arranged to receive the second end of the tube. The internal diameter of the first sleeve portion may step down from a first wider diameter to a second narrower diameter in a direction towards the central portion thereby forming a shelf inside the first sleeve portion. A second sleeve portion may project outwardly from the second end of the central portion. A screw thread may be disposed on the inside wall of the second sleeve portion.

The second end of the tube may be inserted into the second sleeve portion until the first raised portion abuts the shelf inside the first sleeve portion and, optionally, the first end of the tube abuts the first end of the central portion thereby bringing the first end of tube into fluid connection with the conduit passing through the central portion of the second support portion.

In some embodiments, prior to inserting the second end of the tube into the first sleeve portion of the second support portion, a second washer may be passed over the second end of the tube until it abuts the second raised portion. In this way, when the second end of the tube is inserted into the first sleeve portion, the second washer may become sandwiched between the second raised portion of the tube and the shelf inside the first sleeve portion to form a seal. Such an arrangement may advantageously allow the sensing arrangement to tolerate pressures of 40 bar or more without leaking.

The second cover portion may be generally cup shaped, having four walls and a base defining an internal space. A tube portion in fluid connection with an aperture in the base of the second cover portion may project upwardly into the internal space to define the locating portion. A screw thread disposed on the outside of the tube portion may allow the second cover portion to engage with the screw thread disposed on the inside wall of the second sleeve portion of the second support portion, thereby providing for attachment of the second cover portion to the second support portion. The second support portion and/or the second cover portion may suitably comprise a plastic material. The second support portion and/or the first cover portion may, for example, be injection moulded.

In some embodiments, the first and second cover portions may define first and second halves of a trapezoidal prism. For example, each of the first and second cover portions may be generally cup shaped having four square or rectangular walls and a trapezoidal shaped base defining an internal space. In this way, the resulting compartment for accommodating at least a portion of the tube may be generally trapezoidal prism (i.e. 3D trapezoidal) in shape.

In some alternative embodiments of the invention, the sensing arrangement may comprise first and second abutment portions. The first and second abutment portions may be arranged to abut one another to locate the first and second abutment portions with respect to the tube. Suitably, the first and second abutment portions may be arranged to abut one another to form a compartment for accommodating at least a portion the tube.

Each of the first and second abutment portions may comprise an engagement portion for engaging with the locating portion of the first and second housing portions. The first and second housing portions may be arranged to connect to one another to form a compartment for accommodating the abutment portions. The locating portions of the first and second housing portions may receive the engagement portions of the first and second abutment portions to locate the first and second housing portions with respect to the abutment portions.

The first and/or second abutment portion may suitably comprise a plastic material. The first and/or second abutment portion may, for example, be injection moulded.

Suitably, a first and/or second washer may be provided between the first and/or second engagement portions and the first and/or second locating portions. The first and/or second washer may suitably be O-shaped. The first and/or second washer may optionally comprise rubber, silicone, or any other suitable elastomeric material. In some embodiments, the first and/or second washer may be a rubber O-ring. The presence of a first and/or second washer between the first and/or second engagement portions may advantageously allow the sensing arrangement to tolerate pressures of 40 bar or more without leaking.

In some embodiments, the sensing arrangement may advantageously comprise an attachment point for a removable clip (e.g. bespoke clip), strap, or belt, to enable it to be more easily carried around.

Moreover, optionally, the sensing arrangement may comprise at least one of: a battery or battery arrangement, a processing unit, a memory unit, a communication module. The battery arrangement in the sensing arrangement may provide power to the at least one sensor therein, for operation. It will be appreciated that the battery arrangement can be implemented using a primary battery, a secondary battery, or a combination of a primary battery and a secondary battery. Moreover, the processing unit may process the data acquired by the at least one sensor and provide it to the server arrangement (as discussed later, herein). Suitably, the processing unit of the sensing arrangement may operate to provide the data acquired by the at least one sensor in an encrypted manner to the server arrangement, which may prevent any security threats and risks associated with tampering of such data.

In embodiments in which the sensing arrangement comprises a battery or battery arrangement, the sensing arrangement may also suitably comprise an wireless charging induction coil electrically connected to the battery or battery arrangement. The induction coil may suitably be arranged to generate an electric current in the presence of an alternating magnetic field, which may be used to charge the battery or battery arrangement.

In this way, the battery or battery arrangement may conveniently be wirelessly charged, for example by an induction coil in an external charging station or pad. Advantageously, this may avoid the need for the sensing arrangement to require an external charging socket, for example such as a micro-USB charging port, to allow the battery or battery arrangement to be charged by a cable connected to a power supply.

It has been found that such an external charging socket in the sensing arrangement, for example located in the first or second housing portions, can be susceptible to corrosion by the fluid dispensed by the fluid dispensing system. In particular, the fluid dispensed by the fluid dispensing system may comprise inorganic and/or organic salts, which may increase the conductivity of the fluid and thereby increase the rate of corrosion of such a charging socket, for example due to electrolysis. Moreover, the absence of such an external socket may also reduce ingression of the liquid into the sensing arrangement, which avoiding corrosion of any electronic components arranged inside the sensing arrangement.

Suitably, the sensing arrangement may comprise a memory unit for storing data from the at least one sensor therein. In this regard, the data may be stored in the memory unit of the sensing arrangement until it is provided to the server arrangement; subsequently, the oldest data within the memory unit may be over-written when the memory unit is full. Furthermore, the communication module may send (namely, communicate) data acquired by the at least one sensor of the sensing arrangement to the server arrangement. For example, when the fluid dispensing system is in operation, a ‘gateway device’ may download acquired data from the monitoring unit and send it on to the server arrangement. This gateway device may be a mobile phone. For example, the gateway device may be a mobile phone that connects via near-field wireless communication (for example, via Bluetooth®) to the monitoring unit and optionally uses a mobile network or Wi-Fi connected to the Internet® to send the data onwards to the server arrangement. In some embodiments, the gateway device may be a Bluetooth® gateway.

Specifically, the communication module may communicate the data by employing the data communication network (as discussed in detail later). Moreover, the communication module may be implemented using at least one of: ZigBee® technology, Global Packet Radio Service (GPRS) technology Bluetooth® technology, LTE technology, LoRaWAN technology and the like. Suitably, the communication module may comprise an antenna for transmitting and/or receiving the data.

The sensing arrangement may be connected to the fluid dispensing system. Specifically, the sensing arrangement may be detachably attached to the fluid dispensing system. In an embodiment, the sensing arrangement may be detachably attached (namely, connected) to the dispensing arrangement of the fluid dispensing system. In an example embodiment, the sensing arrangement may be attached between the handle and the lance of the dispensing arrangement. In another embodiment, the sensing arrangement may be detachably attached to the at least one storage unit of the fluid dispensing system Optionally, if the fluid dispensing system does not comprise a lance, in such cases, the sensing arrangement may be placed in proximity to the nozzle. Suitably, the sensing arrangement may be placed along the hose of the dispensing arrangement of the fluid dispensing system. It will be appreciated that sensing arrangement may be attached and used to measure flow of the fluid when the fluid dispensing system is in operation. Moreover, the sensing arrangement may be strategically connected to the fluid dispensing system so as to enable the at least one sensor of the sensing arrangement to measure accurately the operational performance of the fluid dispensing system.

The sensing arrangement may, when in operation, measure the operational performance of the flow of the fluid dispensed through the dispensing arrangement. Notably, the at least one sensor in the sensing arrangement may acquire (namely, measure) the operational performance of the fluid dispensing system. The term “operational performance” refers to the characteristic performance associated with a device, when it is operated. Pursuant to embodiments of the present disclosure, the operational performance of the flow of the fluid dispensed through the dispensing arrangement may describe characteristic performance relating to the fluid dispensing system, when it is operated.

Optionally, the operational performance of the flow of the fluid dispensed may comprise at least one of: a rate of flow of the fluid, a pressure of the fluid, a temperature of the fluid, a location of the fluid dispensing system. In this regard, the flow sensor is employed to measure the flow of the fluid dispensed from the fluid dispensing system. Moreover, a pressure sensor may be employed to measure the pressure of the fluid dispensed from the fluid dispensing system, and/or a temperature sensor may be employed to measure the temperature of the fluid dispensed from the fluid dispensing system. Suitably, the location tracker may be employed to record data relating to the location of the fluid dispensing system.

Optionally, the operational performance of the fluid dispensing system may enable the detection of faults in the fluid dispensing system. In this regard, if the flow of the fluid dispensed has a high pressure and a low flow, then such a combination may indicate a blockage in the dispensing arrangement. Moreover, if the flow of the fluid dispensed has a low pressure and a low flow, then such a combination may indicate a leakage in the dispensing arrangement and/or a problem in the at least one storage unit. Such faults may further lead to identification of, for example, clogging of the dispensing arrangement, clogging of the flow sensor, and so forth.

Optionally, the sensing arrangement may comprise a movement detector arranged to activate the sensing arrangement on detection of movement of the sensing arrangement. Suitably, the movement detector may comprise an accelerometer. In this context, activating the sensing arrangement may mean turning the sensing arrangement from a state in which it is switched off (or on standby) to a state in which it is switched on and therefore in operation. Alternatively, activating the sensing arrangement may mean turning the sensing arrangement from a first (lower) powered state in which the sensing arrangement is partially operable to second (higher) powered state in which the sensing arrangement is fully operable.

The use of a movement detector to activate the sensing arrangement on detection of movement of the sensing arrangement may advantageously prevent a user who does not want to be tracked from tampering with the sensing arrangement (i.e. by purposely not activating the sensing arrangement when dispensing fluid from the fluid dispensing system). Moreover, it may avoid the need for a user to have to remember to activate sensing arrangement, and therefore prevent situations where the user forgets to activate the sensing arrangement when dispensing fluid from the fluid dispensing system

The use of a movement detector to activate the sensing arrangement on detection of movement of the sensing arrangement may also advantageously avoid the need to include an external electrical switch in the sensing arrangement. It has been found that such an external electrical switch in the sensing arrangement, for example located in the first or second housing portions, can be susceptible to corrosion by the fluid dispensed by the fluid dispensing system. In particular, the fluid dispensed by the fluid dispensing system may comprise inorganic and/or organic salts, which may increase the conductivity of the fluid and thereby increase the rate of corrosion of such an external electrical switch. Moreover, the absence of such an external switch may also reduce ingression of the liquid into the sensing arrangement, thereby avoiding corrosion of any electronic components arranged inside the sensing arrangement.

In some embodiments, movement of a movement sensor in the sensing arrangement may activate the operation of the sensing arrangement. Beneficially, employing a movement detector for activating the sensing arrangement can ensure that the sensing arrangement is activated when the fluid dispensing system is operated and further may not require a user of the fluid dispensing system to activate it. Subsequently, the sensing arrangement may be activated when the movement detector senses a movement, for example, when it is picked by the user of the fluid dispensing system.

The sensing arrangement may be configured such that after it has been activated, if no further movement is detected by the movement detector for a predetermined period of time, the sensing arrangement may return to the state in which it was in prior to being activated, for example, a state in which it is switched off (or on standby). This may advantageously reduce power consumption by the sensing arrangement.

Optionally, when the sensing arrangement is activated by the movement detector, the location tracker of the sensing arrangement may be switched on by the sensing arrangement. Subsequently, the location tracker (for example a Global Navigation Satellite System (GNSS)) may search for satellites to determine a position of the sensing arrangement. Moreover, once the fluid dispensing system is operated by the user, the location tracker may record the precise position of the fluid dispensing system.

In some embodiments, when the sensing arrangement is activated by the movement detector, one or more Bluetooth® enabled features of the sensing arrangement may be switched on. Suitably, when the sensing arrangement is activated by the movement detector, one or more Bluetooth® enabled features of the sensing arrangement and the location tracker may be switched on.

Optionally, the sensing arrangement may not record any operational performance when the flow sensor of the sensing arrangement is not activated. Beneficially, not recording any data when there is no flow of the fluid from the fluid dispensing system may reduce power consumption by the sensing arrangement.

In some embodiments, the monitoring apparatus may comprise a server arrangement that is communicably coupled to the sensing arrangement, optionally via the data communication network. Throughout the present disclosure, the term “server arrangement” refers to a structure and/or module that includes programmable and/or non-programmable components configured to store, process and/or share information. Optionally, the server arrangement may include an arrangement of physical and/or virtual computational entities capable of enhancing information to perform various computational tasks. Furthermore, it will be appreciated that the server arrangement may comprise a single hardware server and/or a plurality of hardware servers operating in a parallel and/or distributed architecture. Suitably, the server arrangement may include components such as memory, a processor, a network adapter and the like, to store, process and/or share information with other computing components, such as the device or plurality of devices. Optionally, the server arrangement may be implemented as a computer program that provides various services (such as database service, processing service, and so forth) to other devices, modules and/or apparatus.

Moreover, the term “data communication network” refers to individual networks, or a collection thereof interconnected with each other and functioning as a single large network. Optionally, such a data communication network may be implemented by way of a wired communication network, a wireless communication network, or a combination thereof. It will be appreciated that a physical connection may be established for implementing the wired network, whereas the wireless network may be implemented using electromagnetic radiation emission and reception. Examples of suitable data communication networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet®, second generation (2G) telecommunication networks, third generation (3G) telecommunication networks, fourth generation (4G) telecommunication networks, fifth generation (5G) telecommunication networks and Worldwide Interoperability for Microwave Access (WiMAX®) networks.

In an embodiment, the data communication network may be a cellular network. The cellular network may be to a radio communication network, for example, wherein the cellular network is distributed over land through cells. Specifically, each cell may include a fixed location transceiver, for example, such as a base station. In an embodiment, the data communication network may be a Bluetooth® network. Suitably, the Bluetooth® network may enable transmission of the operational characteristic over small distances without Internet® availability. In such cases, the operational performance transmitted over the Bluetooth® network may be acquired by an intermediary source. The intermediary source may employ a wireless communication network, for example such as a wired communication network and/or wireless communication network, to provide the operational performance to the server arrangement. In some embodiments, ta combination of different types of wireless communication networks may be employed.

The server arrangement may acquire the operational performance of the flow of the fluid dispensed and/or generate the actionable information for adjusting optimal dispensing of the fluid. Specifically, the operational performance acquired (namely, measured) by the sensing arrangement may be provided to the server arrangement. Optionally, the server arrangement may acquire encrypted operational performance of the flow of the fluid dispensed for analysis thereof; optionally, such encryption may employ public-private key encryption, selective data obfuscation using data maps, or a combination thereof. It will be appreciated that when the fluid dispensing system is operated, the operational performance may be recorded. Furthermore, upon recordal of the operational performance for a pre-determined time (for example, a day or a given time), the operational performance may be transmitted to the server arrangement, optionally via the data communication network.

It will be appreciated that the memory unit of the sensing arrangement may be full of data, except when initially utilized, and newly acquired data may be written over older acquired data, for example in the manner of a FIFO memory. The fluid dispensing system may be used in regions where, for the majority of its operating time, there is no data communication network coverage available for providing data to the server arrangement. Therefore, optionally, the gateway devices (e.g. mobile telephones, Bluetooth® gateways or a fixed-installation communication arrangement where the fluid dispensing system sprayers are stored) may be employed to provide the operational performance to the server arrangement. These gateway devices may be connected to the Internet® on an occasional basis. The gateway devices may scan for connection to the sensing arrangement of the fluid dispensing system or when triggered by a user. When the gateway devices find the fluid dispensing system with data that has not been copied to the server arrangement (namely, new data), data may be transferred and downloaded to the server arrangement.

Optionally, therefore, the communication module may be triggered to transmit the operational performance from the sensing arrangement to the server arrangement. Subsequently, once the operational performance is provided to the server arrangement, the sensing arrangement may switch off the communication module until new data (namely, operational performance) is recorded. In an example implementation, the communication module may provide operational performance directly to the server arrangement by employing the data communication network. In another example implementation, the communication module may connect to the gateway device to transfer operational performance thereto, optionally wherein the gateway device provides the operational performance to the server arrangement, via for example, a wired and/or a wireless data communication network. In this regard, optionally, the gateway device is the user device of the user (as discussed later, herein).

Moreover, upon acquiring the operational performance from the sensing arrangement, the server arrangement may generate the actionable information for adjusting optimal dispensing of the fluid, for example a liquid. Specifically, the actionable information may refer to an actionable report that summarizes or gives an account of analysis performed on the operational performance of the flow of the fluid. Such actionable information may aim to enhance output and productivity by enhancing utility of the fluid dispensing system. Optionally, the actionable information may be feedback provided to the user. Suitably, the feedback may enable the user to identify any fault or a mismanagement in operation of the fluid dispensing system. More optionally, the actionable information may be provided to the user in a periodical manner, for example substantially in real-time.

Optionally, the sensing arrangement may comprise a movement detector, for example an accelerometer, arranged to detect shaking of the sensing arrangement by a user. The communication module may be arranged to transmit a signal from the sensing arrangement to the gateway device when the sensing arrangement is shaken such that the movement detector detects a shaking force above a configurational threshold. This signal may include a modified version of the Bluetooth® device name of the sensing arrangement. The gateway device may then display information about the sensing arrangement in such a way that allows the sensing arrangement to be identified amongst other sensing arrangements. Beneficially, this may allow the user of the sensing arrangement to distinguish the sensing arrangement from others, for example, when multiple sensing arrangement are communicating with the gateway device at the same time, in lieu of having physical identifiers on each sensing arrangement.

Optionally, the server arrangement may provide a web platform to a user, optionally via the user-device. More optionally, the web-platform may provide a graphical user interface to the user of the monitoring apparatus. Suitably, the user of the monitoring apparatus may be a person and/or a bot operating the web-platform provided by the server arrangement and/or the fluid dispensing system. In some embodiments, the user may register (namely, sign up) onto the web platform to access at least one of: the operational performance of the flow of the fluid in the fluid dispensing system, the generated actionable information. Typically, the term “user device” refers to an electronic device associated with (or used by) the user. The user device may be capable of performing specific tasks associated with the aforementioned system such as transmitting data and/or receiving data. Furthermore, the user device may be intended to be interpreted broadly to include any electronic device that may be used for voice and/or data communication over the wired communication network and/or the wireless communication network. Examples of suitable user devices include, but are not limited to, smartphones, personal digital assistants (PDAs), handheld devices, wireless modems, laptop computers, personal computers, and networking devices. In some embodiments, the user device may include one or more of a casing, a functioning unit, a memory, a processor, a network interface card, a microphone, a speaker, a keypad, a display, a transmitter, and/or a receiver.

Optionally, the server arrangement may acquire, one or more factors relating to an environment in which the fluid dispensing system is to be operated. For example, the server arrangement acquire, via a the user device, one or more factors relating to an environment in which the fluid dispensing system is to be operated. In some embodiments, the server arrangement may process the one or more factors relating to the environment into a machine-readable format for use by the server arrangement.

In this regard, upon registration of the user onto the web-platform provided by the server arrangement, the server arrangement may acquire the one or more factors relating to the environment in which the fluid dispensing system is to be operated. Suitably, the one or more factors relating to the environment in which the fluid dispensing system is to be operated may comprise at least one of: a drawing of the environment of operation, characteristic information relating to the environment of operation. In some embodiments, the fluid dispensing system may be operated in an agricultural field. Suitably, the one or more factors relating to the environment of an agricultural field may include a drawing of the agricultural field, at least one type of crop planted in the agricultural field, a nature of construction of the agricultural field (such as, a hydroponic construction, a green-house construction, a net-house construction and the like), a number of sections in the agricultural field (wherein different sections may have different kinds of crop planted therein), information relating to the water supply in the agricultural field, and/or an image of the agricultural field (for example, a top view image).

In some embodiments, the server arrangement may process the one or more factors relating to the environment into a machine-readable format for use by the server arrangement. Specifically, the server arrangement may “understand” a construct (namely, creates a representative model) of the environment where the fluid dispensing system may be operated by processing the one or more factors. Beneficially, “understanding” the construct of the environment may enable the server arrangement to “comprehend” the environment structurally thereby allowing the server arrangement to perform analysis thereon. Moreover, ‘machine-readable format’ refers to a format that is easy to understand and/or process by the server arrangement.

In an example, the server arrangement may process a drawing of an agricultural field and/or an image of the agricultural field by employing edge-detection techniques. Beneficially, employing edge-detection techniques may enable the server arrangement to precisely identify sections and a layout of the agricultural field. In some embodiments, the server arrangement may provide a plurality of versions of the edge-detected field to the user, thereby allowing the user to choose the most relevant edge-detected field that clearly defines the agricultural field.

In some embodiments, the server arrangement may register the one or more factors relating to the environment where the fluid dispensing system is operated corresponding to a registration of the user of the fluid dispensing system. For example, the server arrangement may register the sensing arrangement employed by the user so as to create a specific database for the user. It will be appreciated that a given user may employ a plurality of sensing arrangements. Suitably, each of the plurality of sensing arrangements may be registered corresponding to the given user, and the given user may also register one or more factors relating to an environment of operation of each of the plurality of sensing arrangements. More optionally, a given sensing arrangement may be registered by a user by providing a unique identification number associated with the given sensing arrangement to the server arrangement, via the user device.

Optionally, the server arrangement may provide, for example via the user device, curated information based on the one or more factors relating to the environment in which the fluid dispensing system is to be operated. Notably, the curated information based on the one or more factors relating to the environment in which the fluid dispensing system is to be operated may provide the user with a template for analysis of the environment.

In an example, when the fluid dispensing system is employed in an agricultural field, the curated information may comprise, for example, a list of possible (namely most plausible) pests and diseases in the agricultural field based on crops planted, a list of possible pests and diseases in the agricultural field based on geography of the agricultural field, a probability of a pest attacking the agricultural field, a probability of development of a disease the agricultural field, an identifying feature associated with each of the possible pests and diseases and a list of chemical compounds (namely, pesticides and biopesticides) relating to each of the pests and diseases. Such curated information may optionally be employed during crop scouting in the agricultural field. Beneficially, such curated information may enable a user to identify early signs and symptoms of occurrence of any abnormality in the environment where the fluid dispensing system is to be operated. Moreover, the curated information may enable the user to develop a deeper understanding of the environment, thereby enhancing productivity (of, for example, crops gown) in the environment.

It will be appreciated that crop scouting is a process of surveying through a given field and recording pests and diseases observed in the given field. One of the most important curated information that a given user can have for deploying the fluid dispensing system is a spatial map of the observed pests and diseases scouted in the given field. Such information can be combined with other information to predict a likely distribution of the pest or disease beyond observed points visited when surveying.

Optionally, the curated information may optimize a time spent for such scouting of the crops in an environment of the given field by providing pre-defined templates for each crop. This may further enable the user to identify precisely, for example, pests and diseases, based on a local geography and seasonal frequency. In this regard, optionally, the server arrangement may weigh a relevancy of neighbouring farms to generate the curated information. Moreover, the curated information may optionally be ranked based on a relevance or probability of occurrence. In an example embodiment, the curated information may comprise a list of pests that potentially occur in the environment. In such a case, pests that are more likely to occur in the environment may be placed at a top of the list, which may help reduce personnel confusion and difficulty in understanding the curated information.

More optionally, the curated information may enable targeted and precise guidance for the user of the fluid dispensing system for application of the fluid in the environment. In an example, the curated information may identify a probability of infestation of pests and/or diseases in different sections of an agricultural field. Subsequently, the curated information may specify sections with higher risks of pests and/or diseases thereby enabling intervention of user before development of the pests and/or diseases. Beneficially, such early intervention of the user may reduce an amount of the fluid (e.g. pesticide or biopesticide) to be applied in the agricultural field, and may therefore reduce or prevent health hazards associated with overuse thereof. Suitably, the curated information may keep track of the distribution of pests and/or diseases within the agricultural field that could improve targeting of the fluid (e.g. pesticide or biopesticide), thereby allowing strategic application thereof.

Optionally, the actionable information for adjusting optimal dispensing of the fluid may be determined based on the one or more factors relating to an environment in which the fluid dispensing system is to be operated. In this regard, the server arrangement may analyse the operational performance of the flow of the fluid from the fluid dispensing system in coherence with the environment wherein the fluid dispensing system is to be operated, to identify any deviations. Such deviation may be caused due to, for example, a rate of the flow of the fluid dispensed from the fluid dispensing system, a position (namely, location) of operation of the fluid dispensing system, a type of fluid (for example, a liquid) dispensed from the fluid dispensing system, and a temperature and/or pressure of the fluid dispensed from the fluid dispensing system.

Furthermore, the server arrangement may provide the actionable information to the user device to report an operational status of the fluid dispensing system. Specifically, the server arrangement may render the actionable information onto a graphical user interface of the user device. In an example, the user device may be employed to operate the web-platform provided by the server arrangement. Subsequently, the actionable information may be rendered on the graphical user interface of the web-platform. In another example, the actionable information may be communicated to the user device as an SMS, an electronic mail, a pop-up message, a notification message and the like.

It will be appreciated that the actionable information for adjusting optimal dispensing of the fluid may be generated by tracking locations where the fluid has been dispensed (namely, sprayed) and a quantity of the fluid dispensed at each location. The server arrangement may analyse a speed of, for example, a user walking or driving (moving) the fluid dispensing system to generate the actionable information. Subsequently, the actionable information may optionally include an optimal speed for the user moving the fluid dispensing system. This may help to reduce fluid surplus in case of a fast speed of the user or fluid shortage in case of a slow speed of the user. Moreover, the actionable information may provide information for specific dispensing (namely, spot spraying) in the environment. Beneficially, such spot spraying may enable targeting of, for example a pest and/or disease in an agricultural field.

Optionally, the actionable information may be provided in real-time to the user via the user device. In some embodiments, the actionable instruction may be provided as oral instructions in real-time (for example, via use of synthesized voice announcement or a pre-recorded voice announcement).

In an example embodiment, the server arrangement may provide a template for crop pest and disease scouting as curated information to a user of the fluid dispensing system, wherein the fluid dispensing system is operated in an agricultural field. It will be appreciated that crop pest and disease templates may be used for the scouting. By having templates for the scouting, there arises an opportunity for pest and disease names to be standardized and compared amongst scouts and farms. Since the curated information can potentially be impracticably long, elements of the curated information pertaining to pests and diseases may be ordered by a frequency of occurrence locally, taking into account observations from neighbouring farms with similar patterns of observation. By employing such presentation of the element of the curated information, scouts may rarely need to scroll down the list, thereby saving the scouts valuable time and effort.

In some embodiments, the server arrangement may acquire satellite imagery of the agricultural field. The satellite imagery may be regularly updated so as to enable identification of changes owing to, for example, different weather performance (optionally, drone-acquired imagery).

Suitably, the sensing arrangement may measure (namely, senses) the operational performance of the fluid dispensing system and optionally provide it to the server arrangement. The operational performance may be analysed to determine, for example, a route where the fluid dispensing system has been operated based on location recorded and flow of the fluid detected, a volume of fluid dispensed at a given location based on output per minute of the fluid dispensing system, a speed (namely, a rate of spatial movement of the fluid dispensing system when being transported by a given scout) at which the fluid dispensing system is operated, a movement of the dispensing arrangement of the sensing arrangement based on the movement of the accelerometer, a quality of spraying based on the movement of the dispensing arrangement and the rate of flow of the fluid therefrom, and a speed at which the fluid dispensing system is moved when operating.

The analysis of the operational performance may be employed to generate actionable information. In an example, the actionable information may include a guide to specific locations in the agricultural field where the fluid dispensing system is to be operated based on identification of pests and diseases from the curated information. This may advantageously reduce fluid wastage and save costs. Moreover, the actionable information may optionally provide information relating to an amount of output fluid dispensed from the fluid dispensing system. This may allow (namely, enable) identification of any fault in the fluid dispensing system and/or identification of locations where the fluid (such as a pesticide or biopesticide) have not been dispensed in a correct quantity. The actionable information may optionally include directions or instructions for a user, in real-time, so as to help guide the user to specific locations for operation of the fluid dispensing system. Such directions or instructions for the user may optionally be provided by, for example, flashing a light emitting diode (LED) lamp, displaying the direction on the user device, emitting acoustic sound, and stimulating vibrations.

Optionally, in some embodiments, the server arrangement can output measured data via a display option. In some embodiments, the server arrangement may comprise multiple display options. A display option may, for example, show the flow rates recorded during application. Each flow rate record may be displayed as a dot, with the size of the dot proportional to the flow rate. The flow rate may be displayed as the flow in millilitres (ml) divided by the number of seconds between flow measurements being ml/seconds. Optionally, the flow rate can be displayed as litres per minute. The position of the dot may be determined by the GNSS coordinates.

Optionally, a display option can show the volume sprayed. Thus, the display option may allow the user to determine how much has been sprayed and in which locations. Overlapped points, which may for example result from calculating the flow rate during application where the user is not moving, may be summed to display the total volume sprayed in a given spot. Binning criteria may be calculated based on the user's GNSS position. Optionally, the binning criteria may be calculated by a clustering algorithm. The clustering algorithm may, for example, be DBSCAN, k-means or other similar algorithms. Optionally, additional volume information may be displayed per field.

Optionally, the user may select a certain temporary area and display the volume sprayed within that area.

Optionally, the speed at which the sprayer is moving can be displayed in colours, with the colour corresponding to the speed of the user compared to the overall average speed of the user. Optionally, the speed may be calculated based on the GNSS location of each point. Optionally, smoothing may be added to the speed to beneficially more accurately calculate the speed from a first point to a second point. Optionally, the user may be able to adjust the scale of the average speed, beneficially showing more accurate speed data where the overall average speed is significantly different at different GNSS points.

Optionally, a display option may show a different colour for each sensor to distinguish the movement and spraying patterns for each user device. Suitably, names or identification numbers may be assigned to each user device as a means of further differentiating between them.

Optionally, the server arrangement may provide over-the-air (OTA) updates to the sensing arrangement. For example, the sensing arrangement may be configured by such updates so as to perform new operations and/or specific operations as described by the user. Beneficially, such alterations and modifications in operations performed by the sensing arrangement may enable the user to customise the sensing arrangement, thereby enhancing user experience (namely, making the apparatus easier and more convenient to employ).

The present disclosure also relates to the method as described above. Various embodiments and variants disclosed above apply mutatis mutandis to the method.

Optionally, the method may comprise acquiring one or more factors relating to an environment in which the fluid dispensing system is to be operated. For example, the method may acquire, via a user device, one or more factors relating to an environment in which the fluid dispensing system is to be operated. In some embodiments, the method may comprise processing the one or more factors relating to the environment into a machine-readable format for use by the server arrangement.

Optionally, the one or more factors relating to the environment in which the fluid dispensing system is to be operated may comprise at least one of: a drawing of the environment of operation, characteristic information relating to the environment of operation.

In some embodiments, the method may comprise providing, via the user device, curated information based on the one or more factors relating to the environment in which the fluid dispensing system is to be operated.

Optionally, the operational performance of the flow of the fluid dispensed may comprise at least one of: a rate of flow of the fluid, a pressure of the fluid, a temperature of the fluid, a location of the fluid dispensing system.

In some embodiments, the operational performance of the flow of the fluid dispensed through the dispensing arrangement may comprise a change in the GNSS location of the fluid dispensing system over time, and the user device may comprise a graphical interface. In such embodiments, the method may optionally comprise processing the operational performance to provide a first image layer to the user device. The first image layer may comprise a graphical representation of the change in GNSS location of the fluid dispensing system over time.

The method may also comprise obtaining satellite image data associated with the change in the GNSS location of the fluid dispensing system over time to provide a second image layer to the user device. The second image layer may, for example, comprise a satellite photograph. The method may additionally comprise overlaying the first and second image layers on the user device. The first and second layers may suitably be configured so as to be moveable relative to one another on the user device. For example, the user device may comprise a screen for displaying graphical information and the first and second layers may be configured so as to be moveable relative to one another on the screen.

Such an arrangement may allow for the satellite image to be manually aligned with the graphical representation of the change in GNSS location of the fluid dispensing system over time, where the two layers do not automatically align correctly. This can be due to the satellite image being shifted slightly from the correct GNSS coordinates. The manual alignment may be performed by a user via the graphical interface of the user device.

For example, in some cases the satellite image of a field in which the fluid (e.g., such as a pesticide or biopesticde) was known to have been dispensed from the fluid dispensing system may not align correctly with the graphical representation of the change in GNSS location of the fluid dispensing system over time, which may be in the form of a route walked by a person dispensing the fluid from the fluid dispensing system. Thus, such an arrangement may advantageously allow the satellite image of the field to be manually shifted to be aligned correctly with the route walked by the person dispensing the fluid.

A third aspect of the invention provides a sensing arrangement for monitoring operation of a fluid dispensing system, the sensing arrangement comprising:
a tube for fluid connection with the fluid dispensing system, the tube having first and second ends and comprising at least one sensor located within the tube; and
first and second housing portions arranged to connect to one another to form a compartment for accommodating at least a portion the tube, each of the first and second housing portions comprising a locating portion for receiving the first and second ends of the tube respectively;
wherein the tube comprises a first raised portion projecting from the outside of the tube being located at or towards the first end and a second raised portion projecting from the outside of the tube being located at or towards the second end; and
wherein the first and second raised portions are arranged to engage the locating portions of the first and second housing portions respectively, thereby locating the first and second housing portions with respect to the tube.

A fourth aspect of the invention provides a sensing arrangement for monitoring operation of a fluid dispensing system, the sensing arrangement comprising:
a tube for fluid connection with the fluid dispensing system, the tube having first and second ends and comprising at least one sensor located within the tube;
first and second abutment portions arranged to abut one another to locate the first and second abutment portions with respect to the tube and form a compartment for accommodating at least a portion the tube, wherein each of the first and second abutment portions comprises an engagement portion; and
first and second housing portions arranged to connect to one another to form a compartment for accommodating the abutment portions, each of the first and second housing portions comprising a locating portion for receiving the engagement portions of the first and second abutment portions to locate the first and second housing portions with respect to the abutment portions.

### DETAILED DESCRIPTION OF THE DRAWINGS

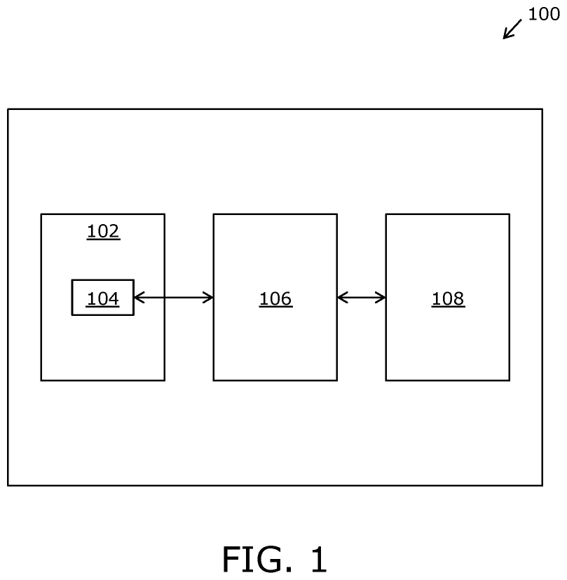

Referring to FIG. 1, there is shown a schematic illustration of a monitoring apparatus 100 that monitors an operation of a fluid dispensing system 102, in accordance with an embodiment of the present disclosure. The fluid dispensing system 102 dispenses a fluid, for example a liquid, a foam, a gas, an aqueous suspension. Notably, the fluid dispensing system 102 comprises at least one storage unit that stores a fluid, a dispensing arrangement, and a pumping arrangement that provides a flow of the fluid from the at least one storage unit to the dispensing arrangement.

Moreover, the monitoring apparatus 100 comprises a sensing arrangement 104 that is connected to the fluid dispensing system 102. The sensing arrangement 104 measures operational performance of the flow of the fluid dispensed through the dispensing arrangement. Additionally, the monitoring apparatus 100 comprises a server arrangement 108 that is communicably coupled to the sensing arrangement 104 via a data communication network 106. Furthermore, the server arrangement 108 acquires the operational performance of the flow of the fluid dispensed, generates an actionable information for adjusting (for example, optimizing) dispensing of the fluid and provides the actionable information to a user device (not shown) to report an operational status of the fluid dispensing system 102.

It will be understood by a person skilled in the art that the FIG. 1 includes a simplified illustration of the monitoring apparatus 100 that monitors an operation of a fluid dispensing system for sake of clarity only, which should not unduly limit the scope of the claims herein. The person skilled in the art will recognize many variations, alternatives, and modifications of embodiments of the present disclosure.

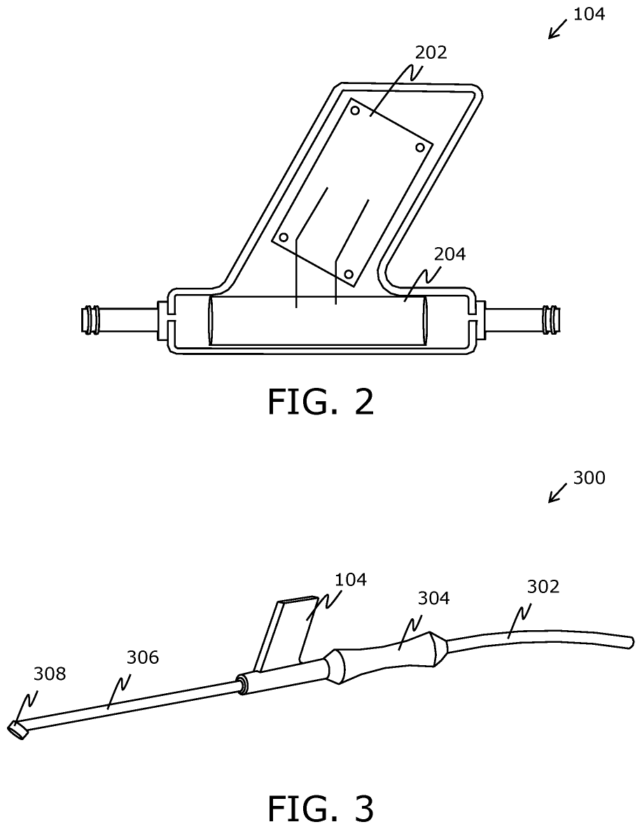

Referring to FIG. 2, there is shown a schematic illustration of a sensing arrangement 104, in accordance with an embodiment of the present disclosure. Notably, the sensing arrangement 104 measures operational performance of a flow of fluid dispensed through a dispensing arrangement of fluid dispensing system. As shown, the sensing arrangement comprises at least one sensor integrated onto a circuit board 202. In this regard, a flow sensor to measure the flow of the fluid dispensed, a pressure sensor, a location tracker to measure a spatial position of the fluid dispensing system, and an accelerometer are integrated onto the circuit board 202. Additionally, a battery arrangement, a processing unit, a memory unit, and a communication module are integrated onto the circuit board 202. Moreover, the sensing arrangement comprises a constant temperature anemometry flow sensor 204 that heats the fluid slightly and further maintains a constant temperature to enable the flow sensor to measure the flow of the fluid dispensed.

Referring to FIG. 3, there is shown a schematic illustration of a dispensing arrangement 300, in accordance with an embodiment of the present disclosure. As shown the dispensing arrangement comprises a hose 302, a handle 304, a lance 306 and a nozzle 308. Moreover, the sensing arrangement 104 is connected to the dispensing arrangement 300. In this regard, the sensing arrangement 104 is placed between the handle 304 and the lance 306.

It will be understood by a person skilled in the art that FIGS. 2 and 3 include a simplified illustration of the sensing arrangement 104 and the dispensing arrangement 300, respectively, for sake of clarity only, which should not unduly limit the scope of the claims herein. The person skilled in the art will recognize many variations, alternatives, and modifications of embodiments of the present disclosure.

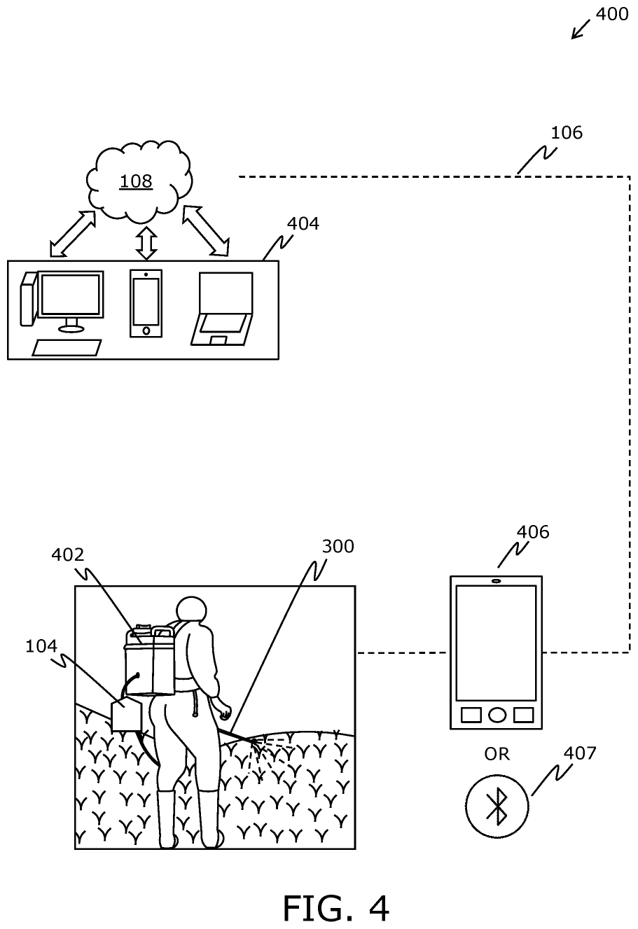

Referring to FIG. 4, there is shown a network environment 400 in which the monitoring apparatus is implemented, in accordance with an embodiment of the present disclosure. Notably, the fluid dispensing system 102 comprises at least one storage unit (depicted as a storage unit 402) that stores a fluid, a dispensing arrangement 300, and a pumping arrangement (not shown) that provides a flow of the fluid from the storage unit 402 to the dispensing arrangement 300. The monitoring apparatus comprises a sensing arrangement 104 that is connected to the fluid dispensing system 102. As shown, the sensing arrangement 104 is connected to the storage unit 402.

The sensing arrangement 104 measures operational performance of the flow of the fluid dispensed through the dispensing arrangement 300. The sensing arrangement 104 may comprise a GNSS sensor and antenna and/or a Bluetooth chip and antenna (not shown). Moreover, the monitoring apparatus comprises a server arrangement 108 that is communicably coupled to the sensing arrangement 104 via a data communication network 106. As shown, the sensing arrangement 104 is connected to the server arrangement 108 via a gateway device 406, and/or Bluetooth® gateway 407.

The gateway device 406 may connect to the sensing arrangement 104, for example via Bluetooth. Additionally, or alternatively, the Bluetooth® gateway 407 may connect to the sensing arrangement 104. Notably, the gateway device 406 and/or Bluetooth® gateway 407 acquires operational performance from the sensing arrangement 104 and further provides the operational performance to the server arrangement 108, via the data communication network 106.

Additionally, the data communication network 106 is implemented using radio waves to facilitate wireless communication of the operational performance from the gateway device 406 and/or Bluetooth® gateway 407 to the server arrangement 108. Typically, the server arrangement 108 acquires the operational performance of the flow of the fluid dispensed, generates an actionable information for adjusting optimal dispensing of the fluid and provides the actionable information to user device 404 to report an operational status of the fluid dispensing system 102.

It will be appreciated that the sensing arrangement 104 optionally directly provides the operational performance to the server arrangement 108 by employing the data communication network 106.

It may be understood by a person skilled in the art that the FIG. 4 includes a simplified illustration of the network environment 400 where the monitoring apparatus is implemented for sake of clarity only, which should not unduly limit the scope of the claims herein. The person skilled in the art will recognize many variations, alternatives, and modifications of embodiments of the present disclosure.

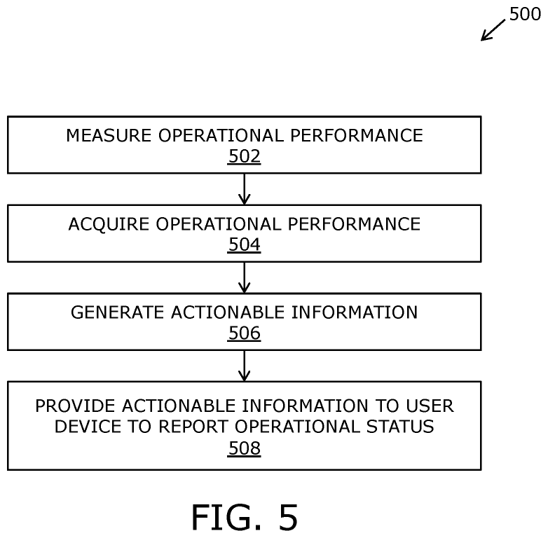

Referring to FIG. 5, there is shown an illustration of a flow chart depicting steps of a method 500 for monitoring operation of a fluid dispensing system, in accordance with an embodiment of the present disclosure. The method is depicted as a sequence of steps in a logical flow diagram, that can be implemented in hardware, software, or a combination thereof, for example as aforementioned.

Notably, the fluid dispensing system comprises at least one storage unit for storing a fluid, a dispensing arrangement, and a pumping arrangement for providing a flow of the fluid from the at least one storage unit to the dispensing arrangement. Moreover, the method 500 is implemented using a monitoring apparatus comprising a sensing arrangement connectable to the fluid dispensing system and a server arrangement communicably coupled to the sensing arrangement via a data communication network. At a step 502, operational performance of the flow of the fluid dispensed through the dispensing arrangement are measured using the sensing arrangement. At a step 504, the operational performance of the flow of the fluid dispensed are acquired by the server arrangement. At a step 506, an actionable information is generated using the server arrangement for adjusting optimal dispensing of the fluid. At a step 508, the actionable information is provided to a user device to report an operational status of the fluid dispensing system.

The steps 502, 504, 506, and 508 are only illustrative and other alternatives can also be provided where one or more steps are added, one or more steps are removed, or one or more steps are provided in a different sequence without departing from the scope of the claims herein.

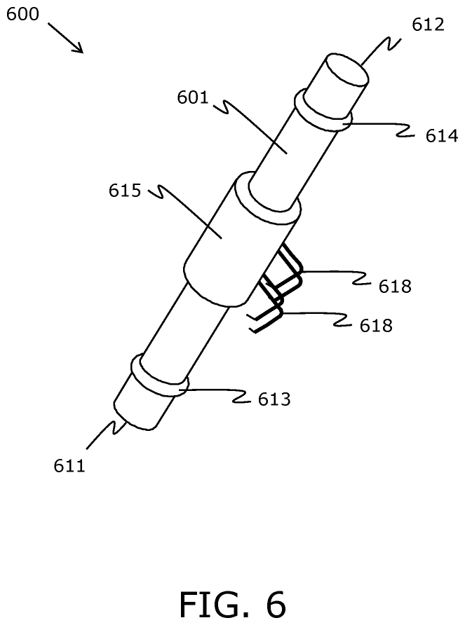

FIG. 6 to 12 illustrate the assembly of a sensing arrangement 600 according to an embodiment of the invention. Referring to FIG. 6, assembly of the sensing arrangement 600 starts from a tube 601 having first and second ends 611, 612. In this particular example, the tube is made from steel. The tube 601 has first and second raised O-ring portions 613, 614 located towards the first and second ends 611, 612 respectively. The first and second raised O-ring portions 613, 614 project outwardly from the tube 601.

The tube 601 has a raised central portion 615 that accommodates two thermometers and heating device (not visible in FIG. 6) located inside the tube 601. A number of electrical wires 618 are connected to the two thermometers and heating device and pass through the raised central portion 615 from the inside of the tube 601 to the outside of the tube 601.

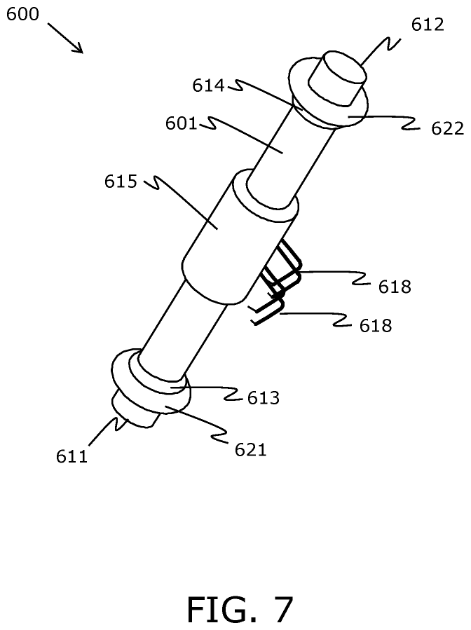

FIG. 7 shows the next stage of the assembly, in which first and second rubber O-rings 621, 622 are slid over the first and second ends 611, 612 respectively of the tube 601 until they abut the first and second raised O-ring portions 613, 614.

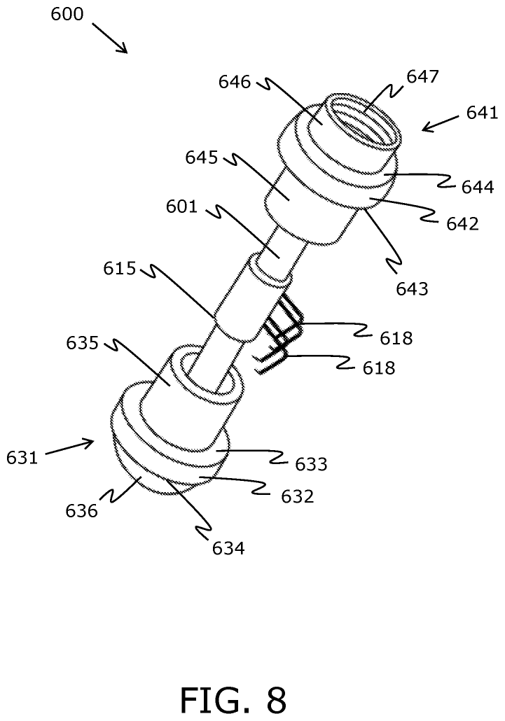

In the next stage of the assembly, shown in FIG. 8, first and second support portions 631, 641 are engaged with the first and second ends 611, 612 of the tube 601. The first support portion 631 has a cylindrical central portion 632 having first and second ends 633, 634. The central portion 632 has a conduit (not visible in FIG. 8), which passes through the central portion 632 from the first end 633 to the second end 634.

A first sleeve portion 635 projects outwardly from the first end 633 and is arranged to receive the first end 611 of the tube 601. The internal diameter of the first sleeve portion 635 steps down from a first wider diameter (being of a diameter slightly larger than the first rubber O-ring 621), to a second narrower diameter (being of a diameter slightly larger than the first end 611 of the tube 601) in a direction towards the central portion 632 thereby forming a shelf (not visible from FIG. 8) inside the first sleeve portion 635.

A second sleeve portion 636 projects outwardly from the second end 634. A screw thread 637 is disposed on the inside wall of the second sleeve portion 636.

The first end 611 of the tube 601 is slid into the first sleeve portion 635 of the first support portion 631 until the first rubber O-ring 621 abuts the shelf inside the first sleeve portion 635 and the first end 611 of the tube 601 abuts the first end 633 of the central portion 632 thereby bringing the tube 601 into fluid connection with the conduit passing through the central portion 632. The first rubber O-ring 621 becomes sandwiched between the first raised O-ring portion 613 of the tube 601 and the shelf inside the first sleeve portion 635 to form a watertight seal.

The second support portion 641 is identical in structure to the first support portion 631, having a cylindrical central portion 642 that has first and second ends 643, 644. The central portion 642 has a conduit (not visible in FIG. 8), which passes through the central portion 642 from the first end 643 to the second end 644.

A first sleeve portion 645 projects outwardly from the first end 643 and is arranged to receive the second end 612 of the tube 601. The internal diameter of the first sleeve portion 645 steps down from a first wider diameter (being of a diameter slightly larger than the second rubber O-ring 622), to a second narrower diameter (being of a diameter slightly larger than the second end 612 of the tube 601) in a direction towards the central portion 642 thereby forming a shelf (not visible from FIG. 8) inside the first sleeve portion 645. A second sleeve portion 646 projects outwardly from the second end 644. A screw thread 647 is disposed on the inside wall of the second sleeve portion 646.

The second end 612 of the tube 601 is slid into the first sleeve portion 645 of the second support portion 641 until the second rubber O-ring 622 abuts the shelf inside the first sleeve portion 645 and the second end 612 of the tube 601 abuts the first end 643 of the central portion 642 thereby bringing the tube 601 into fluid connection with the conduit passing through the central portion 642. The second rubber O-ring 622 becomes sandwiched between the second raised O-ring portion 614 of the tube 601 and the shelf inside the first sleeve portion 645 to form a watertight seal.

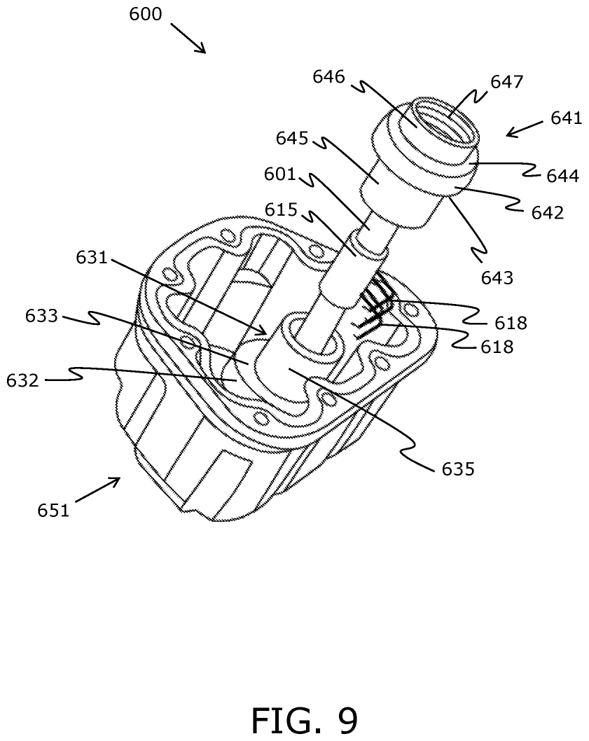

Referring now to FIG. 9, a first cover portion 651 is connected to the first support portion 631. The first cover portion 641 is generally cup shaped, having four walls and a base defining an internal space. A tube portion (not visible in FIG. 9) in fluid connection with an aperture in the base of the cover portion 651 projects upwardly into the internal space. A screw thread disposed on the outside of the tube portion allows the first cover portion 651 to engage with the screw thread 637 disposed on the inside wall of the second sleeve portion 636 of the first support portion 631, so that the first cover portion 651 can be screwed on to the first support portion 631.

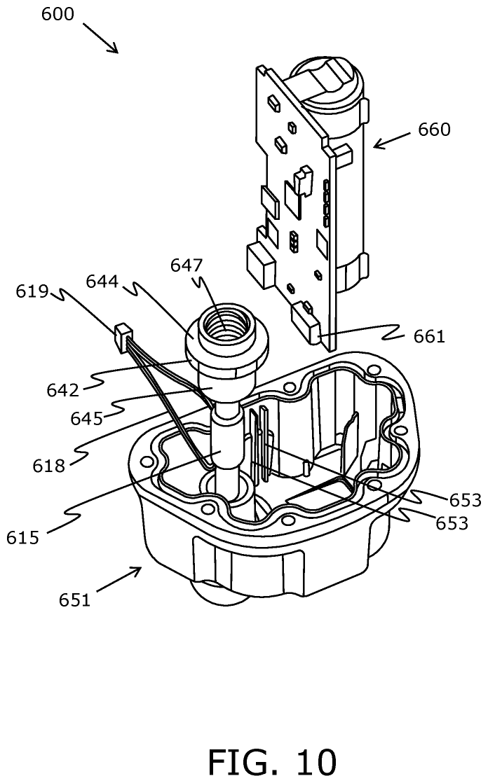

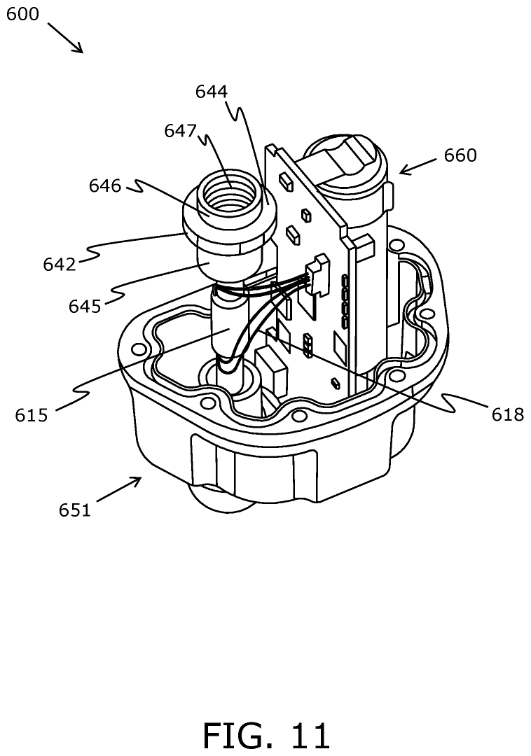

Referring now to FIGS. 10 and 11, the next stage of the assembly involves joining the wires 618 to a connector 619 and then inserting a PCB assembly 660 into the internal space of the first cover portion 651. A pair of vertical ribs 653 on the inside of one of the walls of the cover portion 651 is used to guide the PCB assembly into position. Once the PCB assembly 660 has been slid into position in the first cover portion 651, the connector 619 is connected to the PCB assembly 660.

The PCB assembly 660 has a USB port 661 which aligns with an opening in the cover portion 651, thereby allowing a USB cable or device to be connected to the assembly 660 from outside of the cover portion 651.

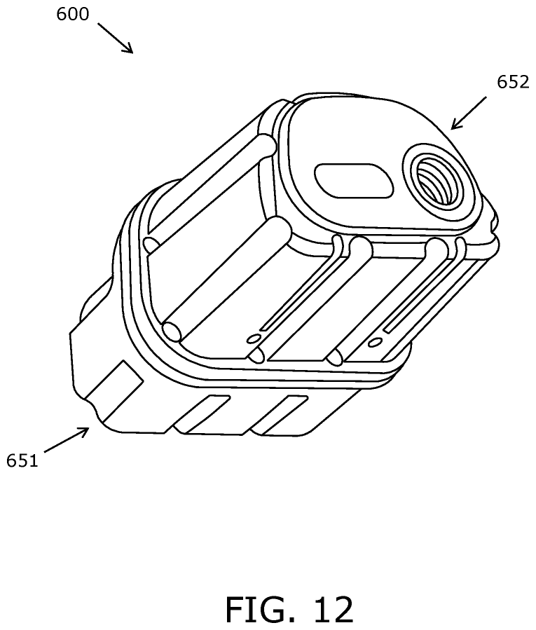

In the final step of the assembly of the sensing arrangement 600, a second cover portion 652 is connected to the second support portion 641, as shown in FIG. 12. The first and second cover portions 651, 652 are screwed together to seal the sensing arrangement 600. The sensing arrangement 600 may advantageously tolerate pressures of 40 bar or more.

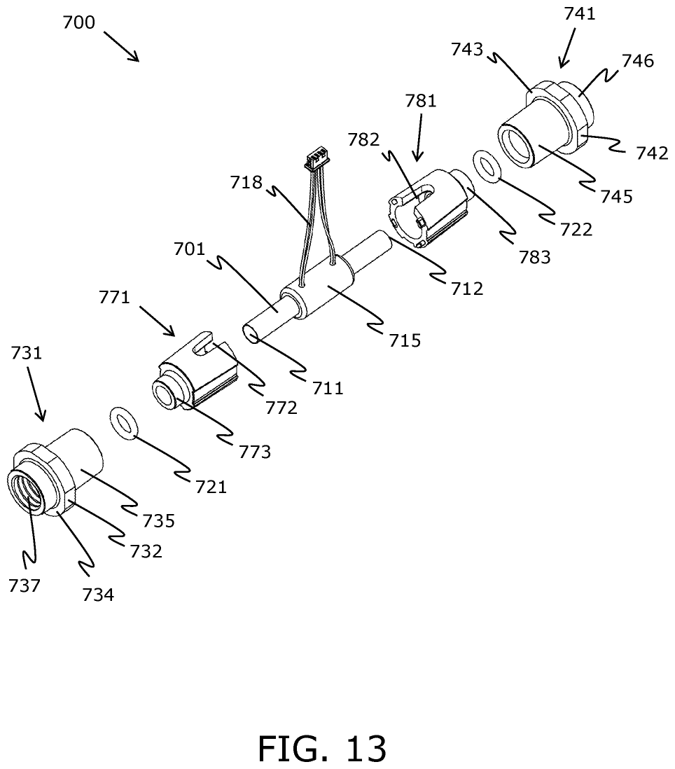

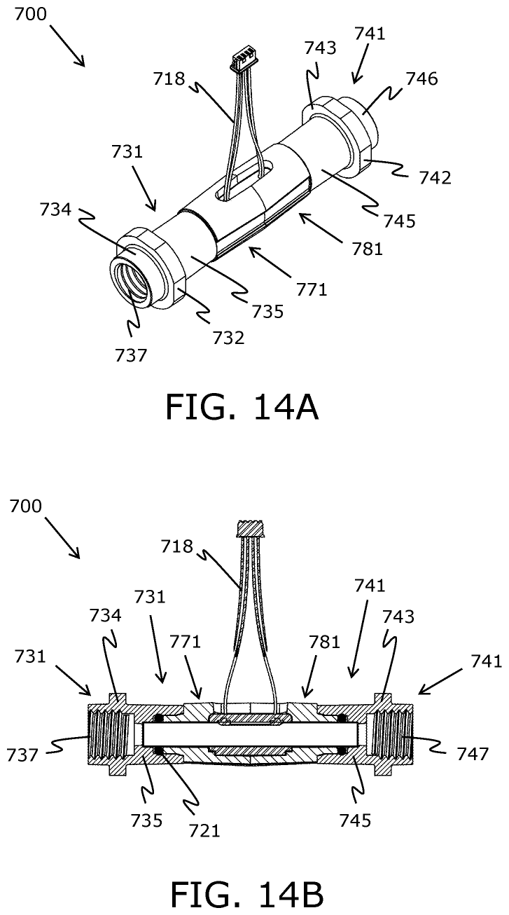

FIGS. 13 and 14 illustrate the assembly of a sensing arrangement 700 according to another embodiment of the invention. Referring to FIG. 13, assembly of the sensing arrangement 700 starts from a tube 701 having first and second ends 711, 712. In this particular example, the tube is made from steel. Unlike the tube 601 of the sensing arrangement 600 described in FIGS. 6 to 12, the tube 701 does not have raised O-ring portions.

The tube 701 has a raised central portion 715 that accommodates two thermometers and heating device (not visible in FIG. 13), which are located inside the tube 701. A number of electrical wires 718 are connected to the two thermometers and heating device and pass through the raised central portion 715 from the inside of the tube 701 to the outside of the tube 701.

In the assembly of the sensing arrangement 700, first and second abutment portions 771, 781 are engaged with the with the first and second ends 711, 712 of the tube 701, such that the first and second abutment portions 771, 781 abut one another at the mid-point of the tube 701. Each of the first and second abutment portions 771, 781 has a recess 772, 782 for accommodating the wires 718 of the tube 701.

Each of the first and second abutment portions 771, 781 has an engagement portion 773, 783 arranged to receive rubber O-rings 721, 722. First and second support portions 731, 741 are then engaged with the engagement portions 773, 783 of the first and second abutment portions 771, 781, as shown in FIGS. 14A and 14B.

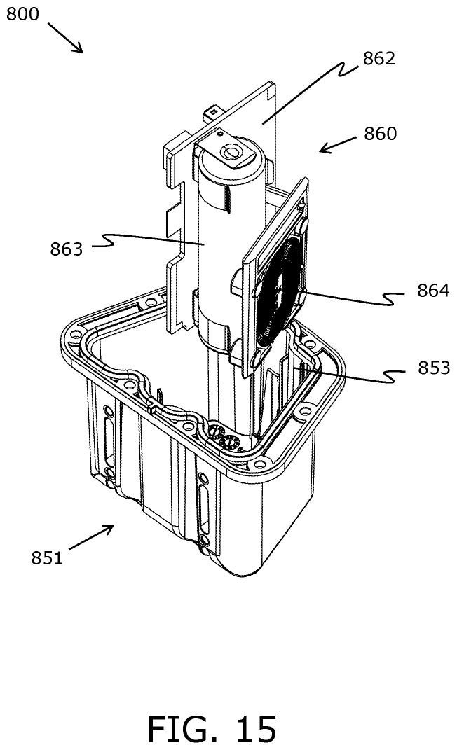

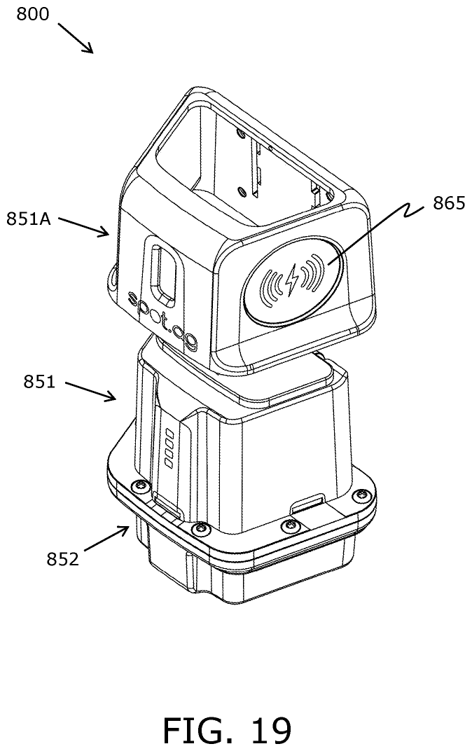

FIGS. 15 to 20 illustrate the assembly of a sensing arrangement 800 in accordance with a further embodiment of the invention. Referring to FIG. 15, the sensing arrangement 800 comprises a PCB assembly 860 and a first cover portion 851. The PCB assembly 860 comprises a PCB board 862 attached to a battery 863. An induction coil 864 is attached to the opposite side of the battery 863 and is electrically connected to the battery 863. The induction coil 864 generates an electric current in the presence of an alternating magnetic field, which allows the battery 863 to be wirelessly charged by an external charging station or pad (not shown in FIG. 15).

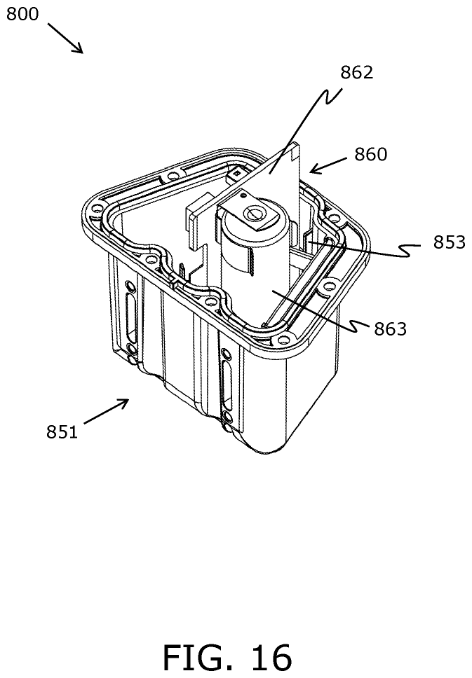

Referring to FIG. 16, the PCB assembly 860 is inserted into the first cover portion 851 using a pair of vertical ribs 853 on the inside of one of the walls of the first cover portion 851 to guide the PCB assembly 860 into position. The PCB assembly 860 is arranged inside the first cover portion 851 such that the induction coil 864 lies flush against one of the walls of the first cover portion 851. The facilitates the charging of the induction coil 864 by an external charging station or pad being held close to the external side of said wall of the first cover portion 851.

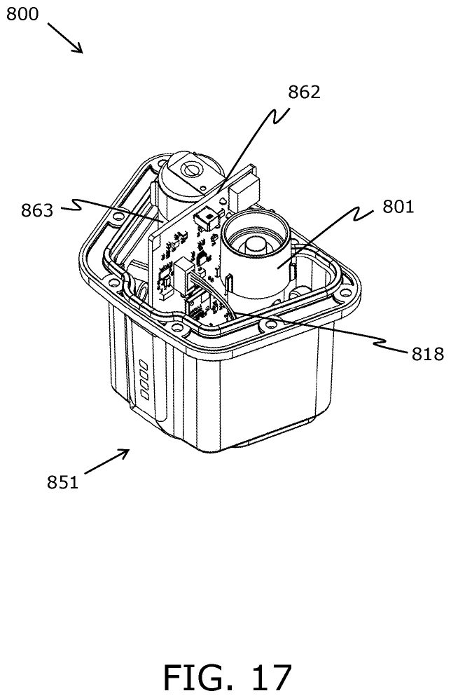

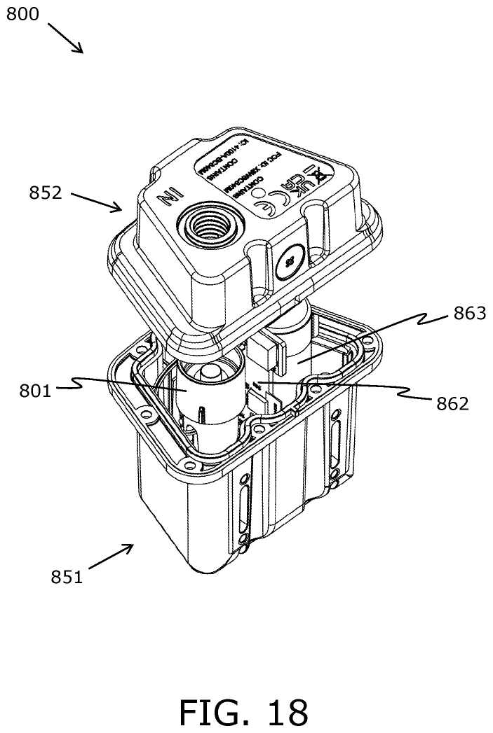

Referring to FIG. 17, a sensor tube 801 is inserted into the first cover portion 851 and connected to the PCB assembly 860 by electrical wires 818. A second cover portion 852 is then attached to the first cover portion 851, as shown in FIG. 18, which seals the PCB assembly 860 and sensor tube 801 inside the first and second cover portions 851, 852. An outer cover portion 851A is then slid over and attached to the first cover portion 851. One wall of the outer cover portion 851A, which corresponds to the wall of the first cover portion 851 against which the induction coil 864 lies flush, comprises an embossed portion 865 embossed with a wireless charging symbol, to externally indicate the nearest location of the induction coil 864 inside the sensing arrangement 800 to a user.

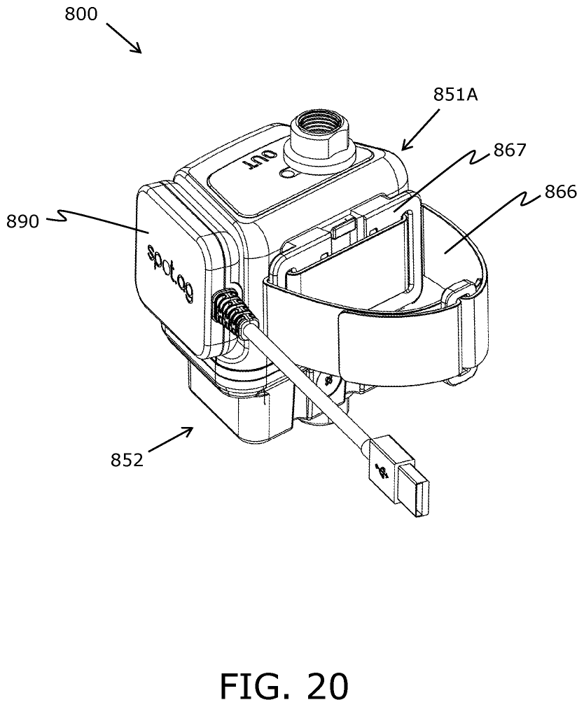

Referring to FIG. 20, the fully assembled sensing arrangement 800 is completed with a removable bespoke clip 867 and a strap 866 for attachment to either a user's body or a fluid dispensing device (not shown in FIG. 20). The sensing arrangement 800 can be wirelessly charged by holding a USB charging pad 890 against embossed portion 865. The USB charging pad 890 generates an alternating magnetic field, which in turn generates an electric current in the induction coil 864, which charges the battery 863.

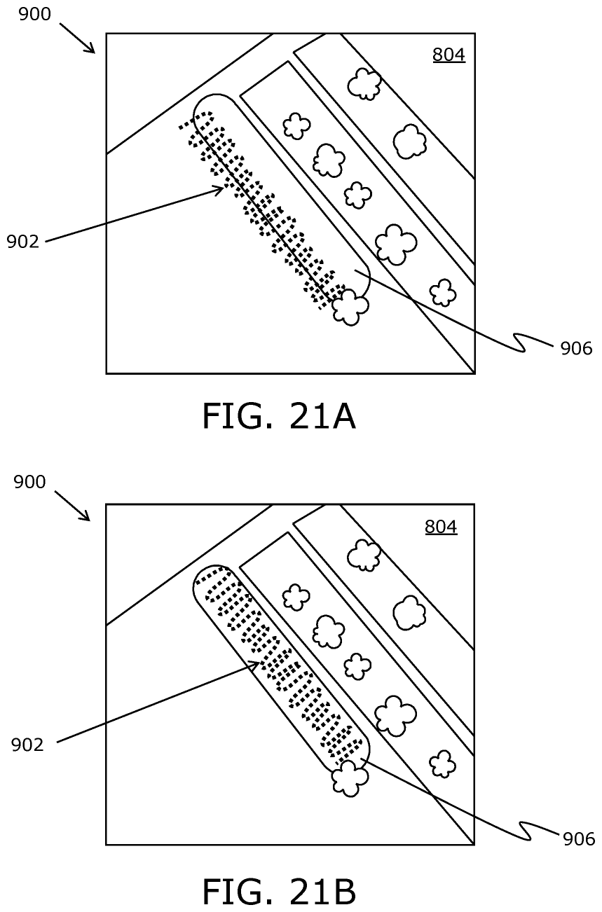

FIG. 21A is a schematic illustration of overlayed images 900 of a GNSS track 902 of the route walked by a crop sprayer and the satellite image 904 of the corresponding GNSS coordinates. The overlayed images 900 are displayed on the screen of a user device such as a mobile phone, tablet, or computer. As can been seen from FIG. 21A, the satellite image of a field 906 in which the crop sprayer walked is slightly offset from the GNSS track 902 of the route walked by the crop sprayer.

This error between the satellite image 904 and the corresponding GNSS coordinates is corrected by the user manually shifting the satellite image 904 relative to the GNSS track 902 of the route walked by the crop sprayer on the user device, so that the satellite image of the field 906 is aligned with the GNSS track 902 of the route walked by a crop sprayer as shown in FIG. 21B.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A monitoring apparatus for monitoring an operation of a fluid dispensing system, wherein the fluid dispensing system comprises at least one storage unit for storing a fluid, a dispensing arrangement, and a pumping arrangement for providing a flow of the fluid from the at least one storage unit to the dispensing arrangement;
wherein the monitoring apparatus comprises:
a sensing arrangement that, when in operation, is connected to the fluid dispensing system, wherein the sensing arrangement measures operational performance of the flow of the fluid dispensed through the dispensing arrangement; and
a server arrangement that is communicably coupled to the sensing arrangement via a data communication network, wherein the server arrangement:
acquires the operational performance of the flow of the fluid dispensed and generates an actionable information for adjusting optimal dispensing of the fluid; and
provides the actionable information to a user device to report an operational status of the fluid dispensing system.

2. The monitoring apparatus according to claim 1, wherein the server arrangement:
acquires, via the user device, one or more factors relating to an environment in which the fluid dispensing system is to be operated; and processes the one or more factors relating to the environment into a machine-readable format for use by the server arrangement.

3. The monitoring apparatus according to claim 2, wherein the one or more factors relating to the environment in which the fluid dispensing system is to be operated comprises a drawing of the environment of operation and/or characteristic information relating to the environment of operation.

4. The monitoring apparatus according to claim 3, wherein the server arrangement provides, via the user device, curated information based on the one or more factors relating to the environment in which the fluid dispensing system is to be operated.

5. The monitoring apparatus according to claim 1, wherein the sensing arrangement comprises at least one sensor selected from: a flow sensor to measure the flow of the fluid dispensed, a pressure sensor, a location tracker to measure a spatial position of the fluid dispensing system, an accelerometer, a constant temperature anemometry flow sensor, a thermometer.

6. The monitoring apparatus according to claim 1, wherein the sensing arrangement comprises a sensor comprising a location tracker to measure a spatial position of the fluid dispensing system, optionally wherein the location tracker is mounted on or in the sensing arrangement.

7. The monitoring apparatus according to claim 6, wherein the sensing arrangement is wedge shaped, having a wide side and a narrow side opposite the wide side, wherein the location tracker is mounted on or in the sensing arrangement at or towards the narrow side.

8. The monitoring apparatus according to claim 7, wherein the sensing arrangement is trapezoidal prism in shape.

9. The monitoring apparatus according to claim 1, wherein the sensing arrangement comprises a movement detector arranged to activate the sensing arrangement on detection of movement of the sensing arrangement.

10. The monitoring apparatus according to claim 9, wherein the movement detector comprises an accelerometer.

11. The monitoring apparatus according to claim 1, comprising a battery or battery arrangement and wireless charging induction coil electrically connected to the battery or battery arrangement.

12. The monitoring apparatus according to claim 1, wherein the operational performance of the flow of the fluid dispensed comprises at least one of: a rate of flow of the fluid, a pressure of the fluid, a temperature of the fluid, a location of the fluid dispensing system.

13. The monitoring apparatus according to claim 1, wherein the sensing arrangement comprises:
a tube for fluid connection with the fluid dispensing system, the tube having first and second ends and comprising at least one sensor located within the tube; and
first and second housing portions arranged to connect to one another to form a compartment for accommodating at least a portion the tube, each of the first and second housing portions comprising a locating portion for receiving the first and second ends of the tube respectively;
wherein the tube comprises a first raised portion projecting from the outside of the tube being located at or towards the first end; and a second raised portion projecting from the outside of the tube being located at or towards the second end; and
wherein the first and second raised portions are arranged to engage the locating portions of the first and second housing portions respectively, thereby locating the first and second housing portions with respect to the tube.

14. The monitoring apparatus according to claim 13 wherein the first and/or second raised portion extends at least a portion the circumference of the tube, optionally wherein the first and/or second raised portion defines a raised O-ring.

15. The monitoring apparatus according to claim 1, wherein the sensing arrangement comprises:
a tube for fluid connection with the fluid dispensing system, the tube having first and second ends and comprising at least one sensor located within the tube;
first and second abutment portions arranged to abut one another to locate the first and second abutment portions with respect to the tube and form a compartment for accommodating at least a portion the tube, wherein each of the first and second abutment portions comprises an engagement portion;
first and second housing portions arranged to connect to one another to form a compartment for accommodating the abutment portions, each of the first and second housing portions comprising a locating portion for receiving the engagement portions of the first and second abutment portions to locate the first and second housing portions with respect to the abutment portions.

16. The monitoring apparatus according to claim 13, wherein the at least one sensor comprises a thermometer.

17. The monitoring apparatus according to claim 13, wherein the tube comprises a heating device located within the tube.

18. A method for monitoring operation of a fluid dispensing system, the fluid dispensing system comprising at least one storage unit for storing a fluid, a dispensing arrangement, and a pumping arrangement for providing a flow of the fluid from the at least one storage unit to the dispensing arrangement;
wherein the method is implemented using a monitoring apparatus comprising a sensing arrangement connectable to the fluid dispensing system and a server arrangement communicably coupled to the sensing arrangement via a data communication network;
wherein the method comprises:
measuring, using the sensing arrangement, operational performance of the flow of the fluid dispensed through the dispensing arrangement;
acquiring, by the server arrangement, the operational performance of the flow of the fluid dispensed;
generating, using the server arrangement, an actionable information for adjusting optimal dispensing of the fluid; and
providing the actionable information to a user device to report an operational status of the fluid dispensing system.

19. A method for monitoring operation of a fluid dispensing system according to claim 18, wherein the method further comprises:
acquiring, via the user device, one or more factors relating to an environment in which the fluid dispensing system is to be operated; and processing the one or more factors relating to the environment into a machine-readable format for use by the server arrangement.

20. The method for monitoring operation of a fluid dispensing system according to claim 18, wherein the one or more factors relating to the environment in which the fluid dispensing system is to be operated comprises a drawing of the environment of operation and/or characteristic information relating to the environment of operation.

21. The method for monitoring operation of a fluid dispensing system according to claim 20, wherein the method comprises providing, via the user device, curated information based on the one or more factors relating to the environment in which the fluid dispensing system is to be operated.

22. A method for monitoring operation of a fluid dispensing system according to claim 18, wherein the operational performance of the flow of the fluid dispensed comprises at least one of: a rate of flow of the fluid, a pressure of the fluid, a temperature of the fluid, a location of the fluid dispensing system.

23. The method for monitoring operation of a fluid dispensing system according to claim 18, wherein the operational performance of the flow of the fluid dispensed through the dispensing arrangement comprises a change in the GNSS location of the fluid dispensing system over time, and wherein the user device comprises a graphical interface, the method comprising:
processing the operational performance to provide a first image layer to the user device, the first image layer comprising a graphical representation of the change in GNSS location of the fluid dispensing system over time;
obtaining satellite image data associated with the change in the GNSS location of the fluid dispensing system over time to provide a second image layer to the user device, the second image layer comprising a satellite photograph; and
overlaying the first and second image layers on the user device; wherein the first and second layers are configured to be moveable relative to one another on the user device.
